(19) United States
(12) Patent Application Publication
(10) Pub. No.: US 2008/0038704 A1
(43) Pub. Date: Feb. 14, 2008

(54) INTEGRATED BLOOD PRESSURE CONTROL AND CORONARY ARTERY SELF-CARE SYSTEM AND METHOD

(75) Inventors: Sylvia Aruffo, Highland Park, IL (US); Shirley Grey, Northbrook, IL (US); Carol Outland, Carol Stream, IL (US); Judith Franks Farah, Northbrook, IL (US)

Correspondence Address: BELL, BOYD & LLOYD, LLP, P.O. Box 1135, CHICAGO, IL, 60690, US

(73) Assignee: CAREGUIDE SYSTEMS, INC., Buffalo Grove, IL (US)

(21) Appl. No.: 11/771,769

(22) Filed: Jun. 29, 2007

Related U.S. Application Data
(60) Provisional application No. 60/806,201, filed on Jun. 29, 2006.
(60) Provisional application No. 60/806,200, filed on Jun. 29, 2006.
(60) Provisional application No. 60/806,203, filed on Jun. 29, 2006.

(51) Int. Cl. G09B 23/28

(52) U.S. Cl. 434/272

(57) ABSTRACT

Methods and apparatus for integrated blood pressure control and coronary artery care are disclosed. The methods and apparatus enable a user to provide blood pressure control and coronary artery care to himself/herself. For example, after being treated by a doctor for a heart problem, a person may use the disclosed system to prevent additional heart related problems.

### PRIORITY CLAIM

This application is a non-provisional of, claims priority to and the benefit of U.S. Provisional Patent Application Ser. No. 60/806,201 filed Jun. 29, 2006; U.S. Provisional Patent Application Ser. No. 60/806,200 filed Jun. 29, 2006; and U.S. Provisional Patent Application Ser. No. 60/806,203 filed Jun. 29, 2006, the entire contents of which are incorporated herein by reference.

### COPYRIGHT NOTICE

A portion of the disclosure of this patent document contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

The present application relates in general to methods, systems and apparatus for integrated blood pressure control and coronary artery self-care by a person.

### BACKGROUND

The health care system in the United States has dramatically changed in the last several decades. Lengthy hospital stays after surgical and other medical procedures have decreased or have been eliminated, at least in part, to reduce overall health care cost. When patients leave hospitals or do not stay in hospitals, the patients often require more professional home care and/or more self-care at home. Self-care at home has necessitated the need for better, more advanced, more user friendly, and more easier-to-use self-care systems, apparatus and methods. For example, the assignee of the present application has developed and distributed many individual self-care systems. Such self-care systems have typically been designed for self-care after an individual surgical or other medical procedure (such as the Post Surgery Drain System described in U.S. Pat. No. 6,926,708).

Self-care systems, apparatus and methods have also been distributed for individual medical conditions (such as for asthma control, blood pressure control, blood sugar control, and healthy foot care). The assignee of the present application has developed and marketed several individual self-care systems, each focused solely on self-care for an individual medical condition.

However, many people have multiple, different simultaneously existing medical conditions. Multiple, different simultaneously existing medical conditions can be related to each other, or may be unrelated to each other. For instance, a person may have heart disease and high blood pressure. These conditions may be considered to be related, in a sense, because they both relate to the heart. On the other hand, a person may have asthma and high blood pressure. These conditions may be considered to be in a sense, unrelated.

Patients with multiple different simultaneously existing medical conditions can use the known individual self-care systems to individually care for each of their conditions. For instance, a person with heart disease and high blood pressure may use an individual heart disease self-care system and may also use an individual high blood pressure self-care system. While these self-care systems may have some overlapping instructions, they may also have contradictory or inconsistent instructions. The concurrent use of these two individual different self-care systems may also require the person to duplicate certain efforts. Using two or more different self-care systems may also cause the person to become confused, discouraged, or overwhelmed. Moreover, many people tend to be able to handle only a limited amount of information and instructions. Using such multiple individual systems greatly lessens the likelihood that the patient will strictly follow either of the self-care systems. Moreover, even if a person is compliant with both individual self-care systems, the systems may be contradictory to a certain extent or may not be effective as possible. The problems get even more complicated when the person has more than two conditions.

Unfortunately, prior to the present invention, there were no known self-care systems which effectively provide single integrated systems for self-care by people with the multiple different medical conditions which the present disclosure addresses.

Prior to the present invention, these problems were not being addressed or discussed in the healthcare industry. Rather, the medical literature has been first discussing substantial problems with known clinical practice guidelines or treatment protocols. Clinical practice guidelines and treatment protocols are substantially different than self-care systems. Clinical practice guidelines and treatment protocols are standardized guidelines for health care professionals (such as doctors and nurses) to follow when they are treating patients. These clinical practice guidelines and treatment protocols are not intended to be and are not written for patients to follow for self-care and generally are not readily understandable or usable by people other than medically trained professionals.

Milliman Inc., and McKesson Corp. are two nationally recognized companies that are currently distributing clinical practice guidelines and treatment protocols for healthcare professionals (such as doctors and nurses). Every hospital in the United States must adopt one of these two sets of protocols to receive accreditation. These protocols are only for use in hospitals and only for use by healthcare professionals.

The medical literature has been discussing substantial problems with such types of known clinical practice guidelines or treatment protocols. For instance, the Aug. 10, 2005, article entitled “Clinical Practice Guidelines and Quality of Care for Older Patients with Multiple Co-morbid Diseases: Implications for Pay-for-Performances” by Darer J. Boyd CM, et al. published by JAMA provides that:
CONTEXT: Clinical practice guidelines (CPGs) [for doctors to follow] have been developed to improve the quality of health care for many chronic conditions. Pay-for-performance initiatives assess physician adherence to interventions that may reflect CPG recommendations.
OBJECTIVE: To evaluate the applicability of CPGs to the care of older individuals with several comorbid diseases.
DATA SOURCES: The National Health Interview Survey and a nationally representative sample of Medicare beneficiaries (to identify the most prevalent chronic diseases in this population); the National Guideline Clearinghouse (for locating evidence-based CPGs for each chronic disease).
STUDY SELECTION: Of the 15 most common chronic diseases, we have selected hypertension, chronic heart failure, stable angina, atrial fibrillation, hypercholesterolemia, diabetes mellitus, osteoarthritis, chronic obstructive pulmonary disease, and osteoporosis, which are usually managed in primary care, choosing CPGs promulgated by national and international medical organizations for each.
DATA EXTRACTION: Two investigators independently assessed whether each CPG addressed older patents with multiple comorbid diseases, goals of treatment, interactions between recommendations, burden to patients and caregivers, patent preferences, life expectancy, and quality of life. Differences were resolved by consensus. For a hypothetical 79-year-old woman with chronic obstructive pulmonary disease, type 2 diabetes, osteoporosis, hypertension, and osteoarthritis, we aggregated the recommendations from the relevant CPGs.
DATA SYNTHESIS: Most CPG's did not modify or discuss the applicability of their recommendations for older patients with multiple comorbidities. Most also did not comment on burden, short- and long-term goals, and the quality of the underlying scientific evidence, nor give guidance for incorporating patient preferences into treatment plans. If the relevant CPGs were followed, the hypothetical patient would be prescribed 12 medications (costing her 406 dollars per month) and a complicated nonpharmacological regimen. Adverse interactions between drugs and diseases could result.
CONCLUSIONS: This review suggests that adhering to current CPGs in caring for an older person with several comorbidities may have undesirable effects. Basing standards for quality of care and pay for performance on existing CPGs could lead to inappropriate judgment of the care provided to older individuals with complex comorbidities and could create perverse incentives that emphasize the wrong aspects of care for this population and diminish the quality of their care. Developing measures of the quality of the care needed by older patients with complex comorbidities is critical to improving their care.

The Aug. 4, 2005 article, entitled “Following Clinical Practice Guidelines for Older Adults With Several Illnesses” which discusses the JAMA study further explains that:
Current clinical practice guidelines [for doctors to follow] are not written with older adults with multiple illnesses in mind, according to a study in the August 10 issue of JAMA.
The aging of the population and the increasing prevalence of chronic diseases pose challenges to the development and application of clinical practice guidelines (CPGs), according to background information in the article. In 1999, 48 percent of Medicare beneficiaries aged 65 years or older had at least 3 chronic medical conditions and 21 percent had 5 or more.
Clinical practice guidelines are based on clinical evidence and expert consensus to help decision making about treating specific diseases. Most CPGs address single diseases in accordance with modern medicine's focus on disease and pathophysiology. However, physicians who care for older adults with multiple diseases must strike a balance between following CPGs and adjusting recommendations for individual patients' circumstances. Difficulties escalate with the number of diseases the patient has. The limitations of current single-disease CPGs may be highlighted by the growth of pay-for-performance initiatives, which reward practitioners for providing specific elements of care. Because the specific element of care may be based on single-disease CPGs, pay-for-performance may create incentives for ignoring the complexity of multiple comorbid (co-existing illnesses) chronic diseases and dissuade clinicians from providing optimal care for individuals with multiple comorbid diseases.
Cynthia M. Boyd, M.D., M.P.H., from the Center of Aging and Health, Johns Hopkins University, Baltimore, and colleagues examined how CPGs address comorbidity in older patients and explored what happens when multiple single-disease CPGs are applied to a hypothetical 79-year-old woman with 5 common chronic diseases. Selection of these diseases were based on data from the National Heath Interview Survey and a nationally representative sample of Medicare beneficiaries (to identify the most prevalent chronic diseases in this population). The National Guideline Clearinghouse was used to locate evidence based CPGs for each chronic disease. Of the 15 most common chronic diseases, the researchers focused on CPGs for hypertension, chronic heart failure, stable angina, atrial fibrillation, hypercholesterolemia, diabetes mellitus, osteoarthritis, chronic obstructive pulmonary disease, and osteoporosis.
Two investigators independently assessed whether each CPG addressed older patients with comorbidities, goals of treatment, interactions between recommendations, burden to patients and caregivers, patent references, life expectancy, and quality of life. For a hypothetical 79-year-old woman with chronic obstructive pulmonary disease, type 2 diabetes, osteoporosis, hypertension, and osteoarthritis, the authors aggregated the recommendations from the relevant CPGs.
The researchers found that most CPGs did not modify or discuss the applicability of their recommendations for older patients with multiple comorbidities. Most also did not comment on burden, short- and long-term goals, and the quality of the underlying scientific evidence, nor give guidance for incorporating patients preferences into treatment plans. If the relevant CPGs were followed, the hypothetical patient would be prescribed 12 medications (costing her $406 per month) and a complicated nonpharmacological regimen. Adverse interactions between drugs and diseases could result.
“For the present, widely used CPGs offer little guidance to clinicians caring for older patents with several chronic diseases. The use of CPGs as the basis for pay-for-performance initiatives that focus on specific treatments for single diseases may be particularly unsuited to the care of older individuals with multiple chronic diseases. Quality improvement and pay-for-performance initiatives within the Medicare system should be designed to improve the quality of care for older patients with multiple chronic diseases; a critical first step is research to define measures of the quality of care needed by this population, including care coordination, education, empowerment for self-management and shared decision making based on the individual circumstances of older patients,” the authors conclude. (JAMA. 2005; 294:716-724. http://www.jamamedia.org.)

In an accompanying editorial, Patrick J. O'Connor, M.D., M.P.H., of the HealthPartners Research Foundation, Minneapolis, commented on the JAMA study by Boyd et al. as follows:
Despite their limitations, evidence-based CPGs remain an important and necessary tool in the effort to improve health care quality. Strategies to address the limitations of current CPGS need to be developed and implemented, including providing recommendations based on level of evidence for particular patient groups and considering the potential economic and personal burden on the patent and caregiver as well as potential interactions with comorbid conditions. Future CPGs could be improved by including explicit information such as the number needed to treat to obtain a specified benefit, and should also be crafted more systematically to consider the influence of patient-specific factors such as age, life expectancy, and comorbidity on anticipated benefits of interventions. In addition, CPGs could include information on cost of various potential therapies, which may influence patient preferences and patient adherence to therapeutic regimens. Such modifications will increase the value of CPGs to clinicians and patients at the point of car, especially when physicians have too much to do [in a given office visit].
Encouraging customization of care in complex clinical scenarios respects the individuality of patents and the professional judgment of highly skilled physicians and minimizes the problem of overtreating patients most susceptible to drug interactions, drug adverse effects, and medical error. Boyd and colleagues have presented these important ‘in the trenches’ issues in a clear and compelling way. Physicians and designers of CPGs owe it to themselves and their patients to consider these issues carefully and to craft CPGs and pay-for-performance accountability measures that will reinforce excellent clinical care while being mindful of resource use and being respectful of patient preferences and priorities.

The Aug. 17, 2005, article entitled “Guidelines May Fail to Meet Needs of Elderly Patients With Comorbidities” by Karia Gale from Reuters Health also addresses the JAMA study in the following manner:
Current clinical practice guidelines [for doctors to follow] are designed to manage single diseases, offering little guidance to clinicians caring for older patients who have several chronic illnesses, authors of a new study suggest.
“Following clinical practice guidelines for single diseases in patients with multiple chronic conditions is very complex and costly and may lead to adverse consequences, including polypharmacy with its associated risks of adverse effects and drug interactions and even hospitalizations.” Lead investigator Dr. Cynthia M. Boyd told Reuters Health.
This is especially pertinent, she added, because pay-for-performance incentives may be based on quality of care standards created for the management of single diseases, whereas half of patents over age 65 have three or more chronic conditions. The care of these patients accounts for almost 90% of Medicare's annual budget.
“Rewarding physicians based on what is good care for younger patients with single diseases is unrealistic,” the researcher added. “Performance incentives based on this model may penalize physicians caring thoughtfully for older patients and may impact the quality of care those patients receive.”
For their study, Dr. Boyd from Johns Hopkins University in Baltimore and her associates identified the most recently released evidence-based guidelines for hypertension, chronic heart failure, stable angina, a trial fibrillation, hypercholesterolemia, diabetes, osteoarthritis, chronic obstructive pulmonary disease (COPD), and osteoporosis.
They found that only guidelines for diabetes, chronic heart failure, angina, and hypercholesterolemia gave general guidance for patients with several comorbid conditions. None discussed the burden of comprehensive treatment on patients or caregivers, and only the guidelines for chronic heart failure explicitly discussed end-of-life treatment.
Dr. Boyd's group used guidelines to develop a treatment plan for a hypothetical 79-year-old woman with osteoporosis, osteoarthritis, type 2 diabetes, hypertension, and COPD.
If all the recommendations were followed, the patient would require 12 separate medications taken as 19 doses at five times during a typical day. Without any insurance coverage for prescription drugs, that would amount to approximately $400 per month. If she were a typical Medicare patient, her costs with the new Medicare drug benefit would still add up to more than $3700 per year.
“We need to think less about individual disease and more about individual people who are living longer with multiple chronic conditions,” Dr. Boyd said. More research is needed, she added, to form “reasonable estimates of risks, benefits and burdens that are specific to them and their individual circumstances and preferences.”
Dr. Patrick J. O'Connor, from HealthPartners Research Foundation in Minneapolis, Minn., agrees with this assessment, according to his accompanying editorial.
“Ideally,” he writes, “clinical practice guidelines would help physicians select from among multiple evidence-based recommendations those with the greatest potential benefit to a given patient.”

This medical literature and commentary clearly explains the lack of and need for integrated treatment protocols and clinical practice guidelines for healthcare professionals (such as doctors and nurses) to follow in treating patients with multiple different diseases or different medical conditions. Thus, there is clearly a need for integrated treatment protocols and clinical practice guidelines for healthcare professionals (such as doctors and nurses).

Similarly, the existing literature does not appear to suggest that the healthcare industry prior to the present invention has considered integrated protocols for patient self-care. In February, 2005, Milliman and Robertson introduced individual treatment protocols for use by healthcare professionals outside of hospitals and for individual chronic conditions. Health plans have been buying these treatment protocols to start individual disease management programs. However, these treatment protocols for healthcare professionals to follow are not the same as self-care programs that patients (rather than healthcare professionals) must follow at home and usually alone to treat themselves. These treatment protocols would be completely unusable by a person attempting provide self-care for multiple simultaneously existing medical conditions.

Accordingly, there is a substantial need for self-care systems for treating multiple simultaneously existing different medical conditions.

### SUMMARY

The present disclosure provides systems, methods and apparatus that enable a user to provide integrated self-care for blood pressure control and coronary artery care.

In one embodiment, the present disclosure provides an integrated blood pressure control and coronary artery care self-care system. In one embodiment, the self-care system includes at least: (a) a magnet board, (b) a blood pressure monitor, (c) a pill organizer, (d) a nitroglycerin dispenser, (e) a stress management guide, (f) a primary step-by-step guide including a plurality of primary steps associated with blood and arteries at least including a dietary program, a medicine compliance program, a tobacco addiction program, a stress management program, an exercise program, and a medical record keeping program, (g) a secondary step-by-step guide including a plurality of secondary steps associated with the primary steps at least including instructions for how to eat less salt, instructions for how to eat less fat, instructions for how to eat more fiber, instructions for how to eat out, a shopping list, and medicine compliance program steps including (i) instructions on how to schedule ordering of additional pills, (ii) instructions on how to organize pills, and (iii) information on the purpose of different types of pills, and (h) a container for storing these components.

It should be appreciated that one significant benefit of the present disclosure is the increased likelihood that the patient will actually read and use this single set of materials which is substantial less volume than multiple sets of materials for each condition. When a chronic care program delivers multiple sets of materials for these conditions, the sheer amount often discourages the person from trying at all. Even if they do read through everything, they will not learn the most important issue of having these multiple diseases; that is, a person with both Hypertension and Coronary Artery Disease (CAD) is more likely to have a heart attack or stroke than a person who has just one condition or the other. Neither set of independent materials will alert the person to their heightened risk.

The present disclosure avoids another danger that the person will read one set and put the other away for later, often never coming back to it. For instance, if the person reads CAD first, they will seek to avoid fat and eat fiber. But they will miss that they should also avoid salt, which would be a high priority for Hypertension. Eating salmon, for example, may seem like a good option, but salmon has a high salt content. If they read Hypertension first, they will see to avoid salt and fat, but will miss the directive to eat fiber, an important precaution against CAD.

One benefit of the integrated approach disclosed here is that the basic understanding of the multiple diseases is simplified and coherent: both CAD and Hypertension make it harder for the heart to pump blood through the body, but for different reasons. That simple, integrated statement can be a breakthrough understanding for a patient and will not be found in two separate sets of material. Thus, the present disclosure not only provides one integrated set of materials, but also an integrated understanding of how the conditions relate to each other.

Additional features and advantages of the present system are described in, and will be apparent from, the following Detailed Description and the figures.

### BRIEF DESCRIPTION OF THE DRAWINGS

FIG. 1 is a perspective view of an integrated blood pressure control and coronary artery care system of one embodiment of the present disclosure.

FIGS. 2, 3, 4 and 5 are front views of an overview on blood and arteries of one embodiment of the present disclosure.

FIGS. 6 and 7 are front views of a primary step-by-step guide of one embodiment of the present disclosure.

FIG. 8 is a front view of a magnetic board of one embodiment of the present disclosure.

FIGS. 9, 10, 11 and 12 are front views of a secondary step-by-step guides for a “watch-what-you-eat” step of one embodiment of the present disclosure.

FIGS. 13 and 14 are front views of a secondary step-by-step guide for a “take-the-right-pills” step of one embodiment of the present disclosure.

FIGS. 15 and 16 are front views of a secondary step-by-step guide for a “stop smoking” step of one embodiment of the present disclosure.

FIGS. 17A and 17B are front views of a secondary step-by-step guide for a “learn-to-relax” step of one embodiment of the present disclosure.

FIGS. 18 and 19 are front views of a secondary step-by-step guide for a “get-moving” step of one embodiment of the present disclosure.

FIGS. 20, 21, 22 and 23 are front views of a secondary step-by-step guide for a “record-keeping” step of one embodiment of the present disclosure.

FIGS. 24, 25, 26 and 27 are front views of instructions for a blood pressure monitor of one embodiment of the present disclosure.

FIGS. 28 and 29 are front views of reduced-size instructions for blood pressure monitoring of one embodiment of the present disclosure.

FIG. 30 is a front view of a carbohydrate counting book of one embodiment of the present disclosure.

### DETAILED DESCRIPTION OF EXEMPLARY EMBODIMENTS

The system and method described herein provide for integrated blood pressure control and coronary artery self-care of a single person by that person. It should also be appreciated that the system and method of the present disclosure can be employed by another person such as a care-giver, an in-home care provider, a health-care provider for the person being cared for. The disclosed method and system includes a collection of devices and instructions a user may use to simultaneously provide blood pressure control and coronary artery care in an integrated manner. Many of the instructions are in the form of step-by-step guides with illustrations to guide the user through use of the system and method.

It should be appreciated that the different embodiments of the present invention may include: (a) less than all of the components described below, (b) more than the components described below, or (c) one or more substitute or alternative components for one or more of the components described below.

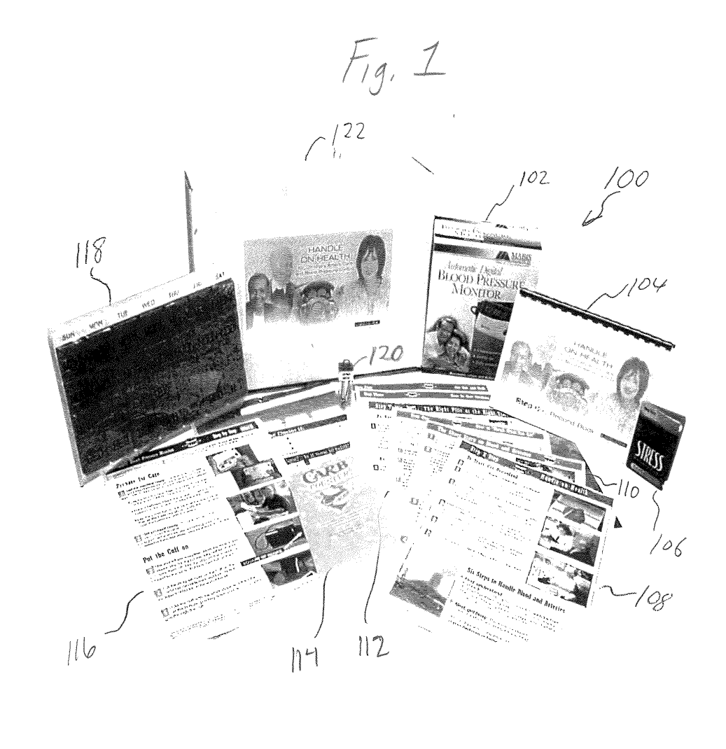

One embodiment of the system of the present disclosure is system 100 illustrated in FIG. 1 which includes a blood pressure monitor 102, a medical record keeping book 104, a stress management pocket pal 106, a primary step-by-step guide 108, an overview information set discussing blood and arteries 110, six secondary step-by-step guides 112, a carbohydrate counting book 114, a blood pressure monitor manual 116, a pill organizer 118, and a nitroglycerin dispenser 120. Preferably, all of these items are packaged together in a suitable container such as a cardboard box 122. In certain embodiments, the blood pressure cuff and related instructions are optional.

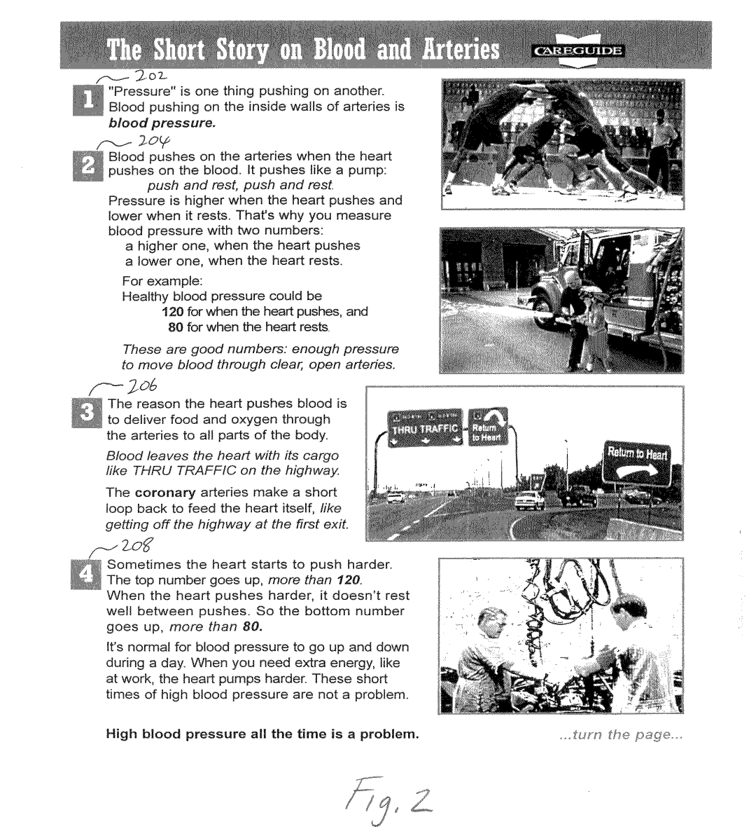

More specifically, for the purpose of educating the user about blood and arteries, the system 100 includes an overview information set on blood and arteries 110. The overview on blood and arteries 110 is illustrated in FIG. 2 through FIG. 5. The overview on blood and arteries 110 is titled “The Short Story on Blood and Arteries.” The overview 110 includes a definition of blood pressure 202, an explanation of why blood pressure is measured with two numbers 204, an explanation of why the heart pushes blood 206, an explanation of high blood pressure 208, an explanation of what makes blood pressure go up 300, an explanation of what makes blood pressure go down 400, three misconceptions about cholesterol 502, and an explanation of what cholesterol tests mean 504. By educating the user about these blood and artery concepts, the user is more likely to understand why each of the six secondary steps (discussed below) are extremely important to follow. As a result of this understanding, the user is more likely to follow each of the steps.

In the definition of pressure 202, the overview 110 defines “pressure” as one thing pushing on another thing and “blood pressure” as blood pushing on the inside walls of the arteries. In the example explanation of why blood pressure is measured with two numbers 204, the overview 110 explains that the heart pushes blood like a pump. This pumping action has a pushing state and a resting state. Pressure is higher during the pushing state and lower during the resting state. Blood pressure is typically measured during both states. Therefore, two different numbers are measured. For example, a blood pressure measurement of 120 during the pushing state and 80 during the resting state is typically considered a healthy blood pressure. These and other simple explanations in the system 100 enable users to fully understand their multiple conditions, with the goal that if a user understands what is happening, the user is more likely to follow the steps to help themselves. The instructions provided in the system also explain to users what they need to do without individually addressing each separate medical condition.

In the example explanation of why the heart pushes blood 206, the overview 110 explains that blood needs to be pushed through the arteries to deliver food and oxygen to the various parts of the body. In addition, the overview 110 explains that coronary arteries make a short loop back to the heart to deliver blood to the heart itself.

In the example explanation of high blood pressure 208, the overview 110 describes: (a) how blood pressure rises when the heart rate is increased; (b) how an increase in blood pressure is normal and provides extra energy when the body is active; and (c) how blood pressure that remains high all the time can be a health problem.

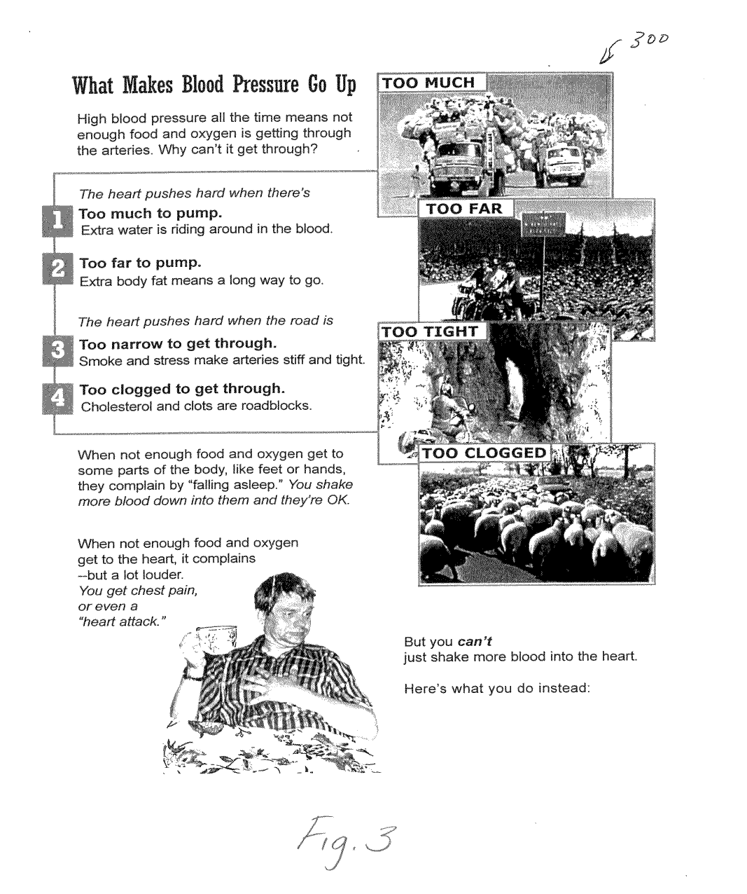

Turning to FIG. 3, in the example explanation of what makes blood pressure go up 300, the overview 110 explains that chronic high blood pressure occurs when food and oxygen cannot get through the arteries to feed the body. This lack of food and oxygen may be caused by extra water in the bloodstream (i.e., too much to pump), excess body fat (i.e., too far to pump), constricted arteries (i.e., too narrow to get through), and/or block arteries (i.e., too clogged to get through). The overview 110 goes on to explain that when some parts of the body (e.g., feet and hands) are deprived of sufficient food and oxygen from an insufficient blood flow, those body parts “fall asleep.” When this happens, the person may be able to simply shake more blood to the deprived portion to correct the problem. However, when the heart is deprived of food and oxygen, chest pain and/or a heart attack may occur. Unlike other portions of the body, the person cannot simply shake additional blood into the heart. Instead, the person must take certain steps to cause their blood pressure to decrease.

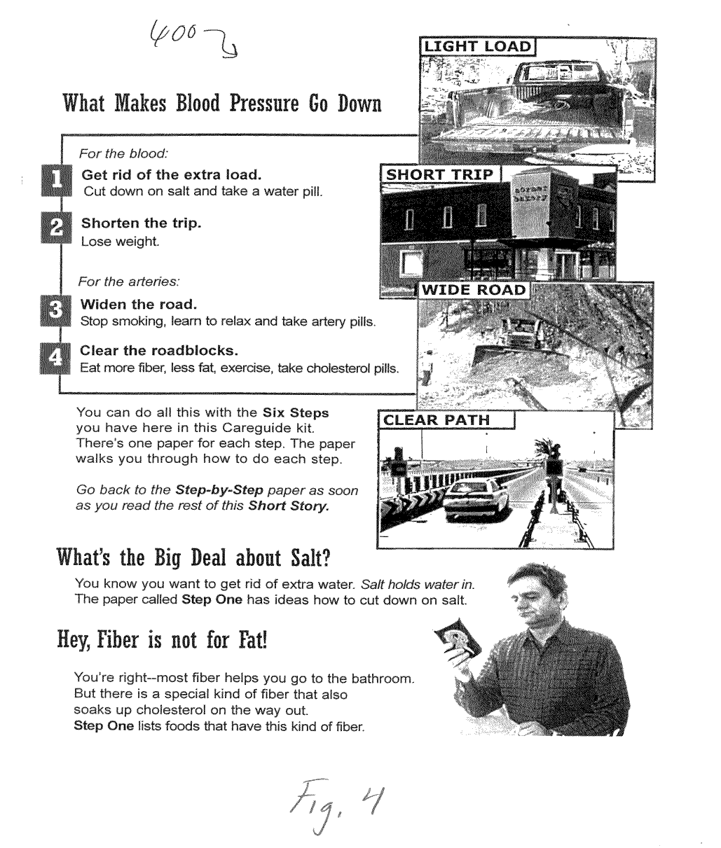

Turning to FIG. 4, in the example explanation of what makes blood pressure go down 400, the overview 110 explains that each of the four things described that cause blood pressure to increase can be addressed in a different way to cause blood pressure to go back down. To decrease extra water in the bloodstream (i.e., less to pump), people may reduce their salt intake and/or take medications that reduces water in the body. To decrease excess body fat (i.e., less distance to pump), the person may need to lose weight. To open arteries (i.e., more room to get through), the person may need to stop smoking, learn to relax to reduce stress, and/or take medications to widen the arteries. To unblock arteries (i.e., less clogged to get through), the person may need to eat more fiber, eat less fat, exercise, and/or take cholesterol medication.

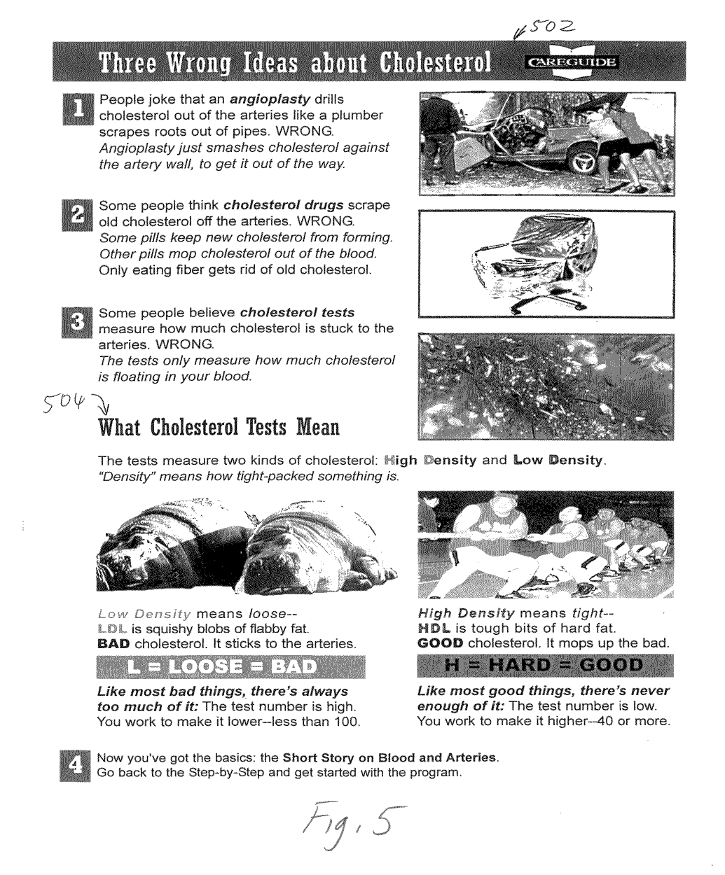

Turning to FIG. 5, in the three misconceptions about cholesterol 214, the overview 110 explains that some people believe that angioplasty removes cholesterol from the arteries. However, angioplasty merely smashes cholesterol against the artery wall to get the cholesterol out of the way. In addition, some people believe that cholesterol drugs scrape old cholesterol from the arteries. However, some medications just prevent new cholesterol from forming, and other medications just remove cholesterol from the blood stream. Only eating a certain type of fiber scrapes old cholesterol from the arteries. In addition, some people believe that cholesterol tests measure the amount of cholesterol stuck in the arteries. However, cholesterol tests only measure the amount of cholesterol that is floating in the blood.

In the explanation of what cholesterol tests mean 504, the overview 110 explains that there are two types of cholesterol. A first type of cholesterol is low density cholesterol (i.e., LDL). Low density cholesterol is squishy blobs of fat that stick to the arteries. This type of cholesterol is unhealthy and may need to be reduced. A second type of cholesterol is high density cholesterol (i.e., HDL). High density cholesterol is tough bits of hard fat that clean the low density cholesterol out of the arteries. The overview explains that this type of cholesterol is healthy and may need to be increased.

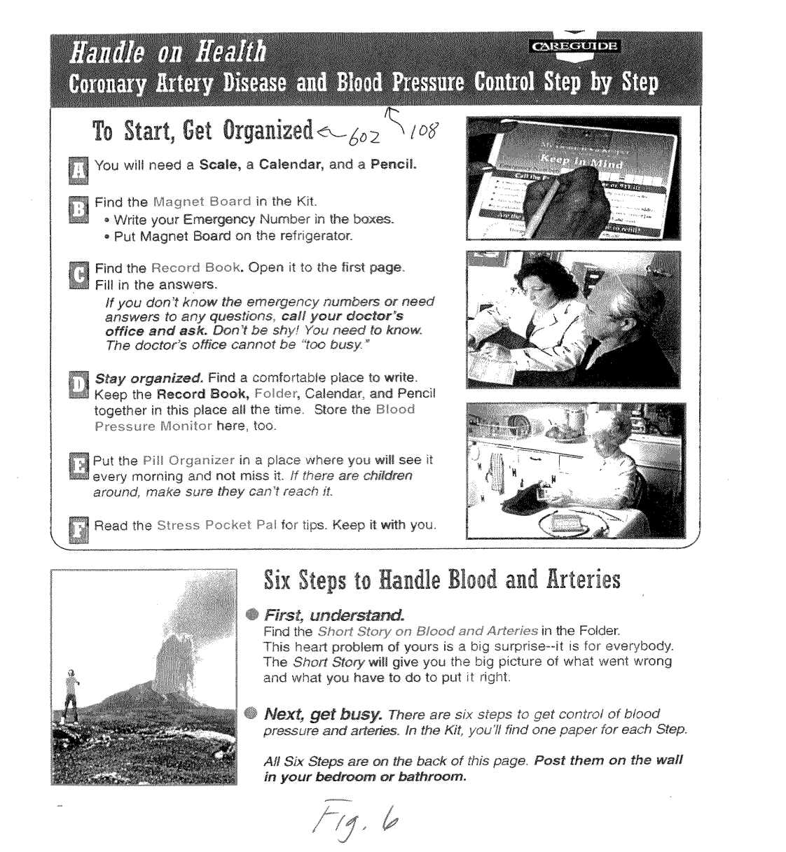

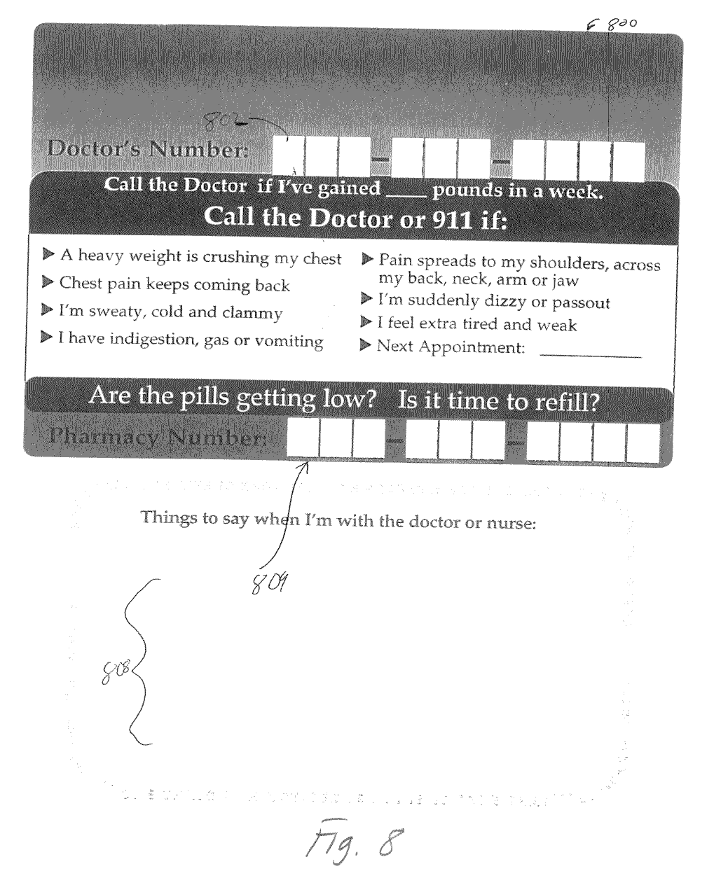

Once the user completes the overview 110, the overview 110 instructs the user to go to the primary step-by-step guide 108 to get started with the system 100. A primary step-by-step guide 108 is illustrated in FIG. 6. The primary step-by-step guide 108 begins with an organization portion 602. The organization portion 602 instructs the user to get a weight scale, a calendar, a writing instrument such as a pencil, and a magnetic board 700 included with the system 100. A magnetic board 800 is illustrated in FIG. 8. The magnetic board 800 may be hung from a refrigerator as a convenient reference for emergency telephone numbers 802, prescription refill telephone numbers 804, reasons to call the doctor 806, and things to remember to tell the doctor or nurse 808.

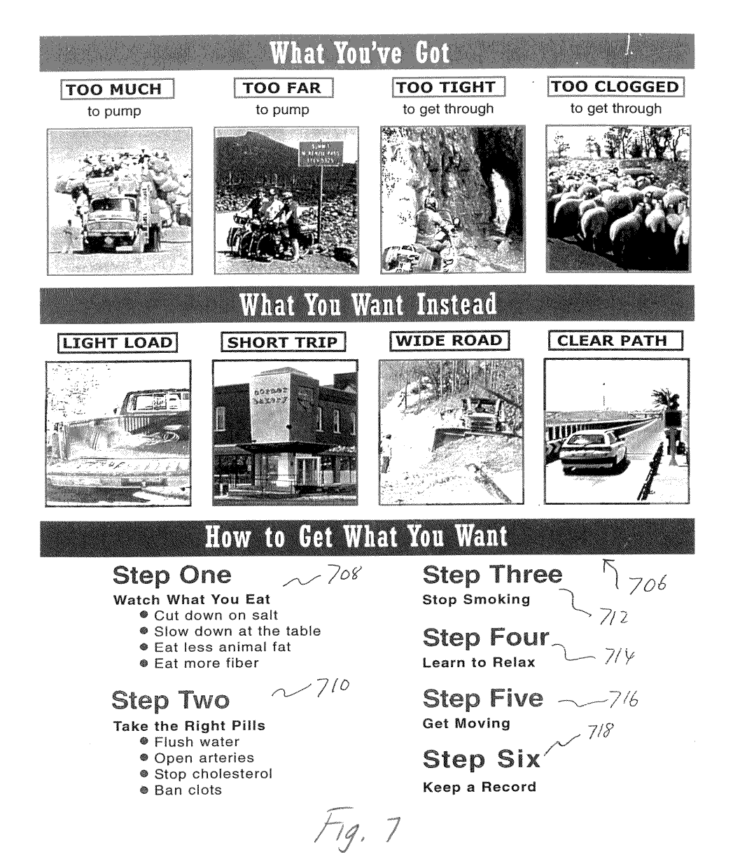

Turning to FIG. 7, a reminder of the overview 110 is provided. Specifically, the overview reminder illustrates by analogy what causes high blood pressure 702 and what creates lower healthy blood pressure 704. In addition, six primary steps 706 are listed for the user. The first step 708 is the watch-what-you-eat step 708. This step includes reducing salt intake, eating slower, eating less animal fat, and eating more fiber. The second step 710 is the take-the-right-medications step. This includes medications that flush excess water, open arteries, prevent cholesterol formation, and remove cholesterol from the blood. The third step 712 is the stop-smoking step. The fourth step 714 is the learn-to-relax (i.e., reduce stress) step. The fifth step 716 is the get-moving (i.e., to exercise) step. The sixth step 718 is the keep-good-medical-records step.

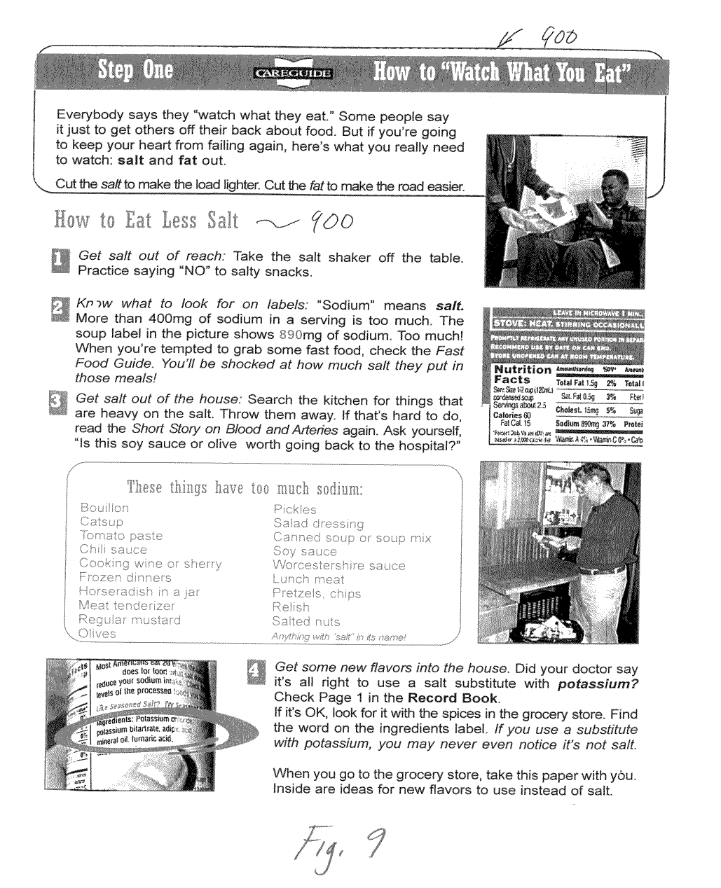

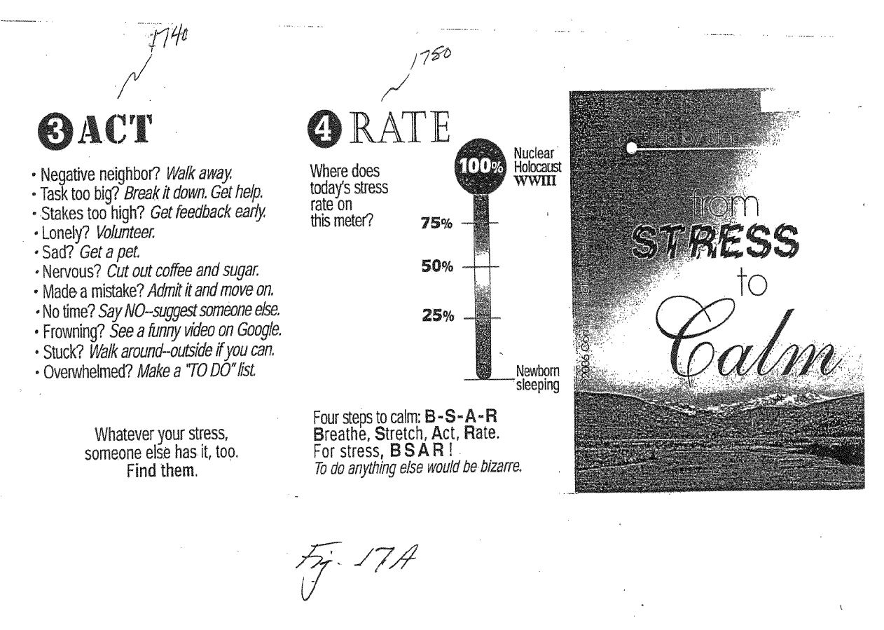

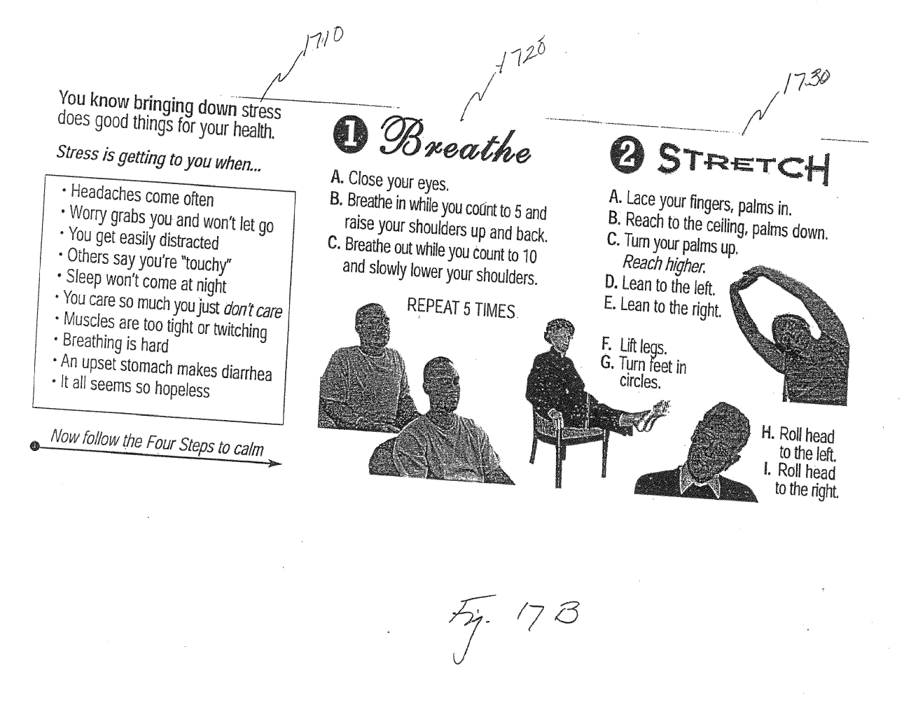

Each of the six primary steps 706 corresponds to one of the six secondary step-by-step guides 112. The secondary step-by-step guides 112 are illustrated in FIG. 9 through FIG. 23.

FIG. 9 through FIG. 12 illustrate a secondary step-by-step guide 900 for the watch-what-you eat step 708 (i.e., the first step). The secondary step-by-step guide 900 includes instructions on how to eat less salt 902, how to eat less fat 1002, how to eat more fiber 1102, and how to survive a night eating out 1202.

FIG. 9 illustrates instructions on how to eat less salt 902. The instructions 902 inform the user to remove the salt shaker from the table and to learn to simply say “no” to salty snacks. The instructions 902 also teach the user how to read nutrition labels to determine salt content (i.e., sodium). By reading the labels and consulting a list 904 of high sodium food items, the user is instructed to remove the high sodium food items from the home. For example, bouillon, catsup, tomato paste, etc. should be removed from the user's home to avoid the temptation. The instructions 902 also teach the user to get new flavors into the home. For example, potassium may be substituted for salt with a doctor's approval. The medical record keeping book 104 includes an instruction to ask the doctor if potassium may be substituted for salt and a place to record the answer. In addition, the how-to-eat-less-salt instructions 902 include a reminder to the user to check the record book 104 for the answer to this question.

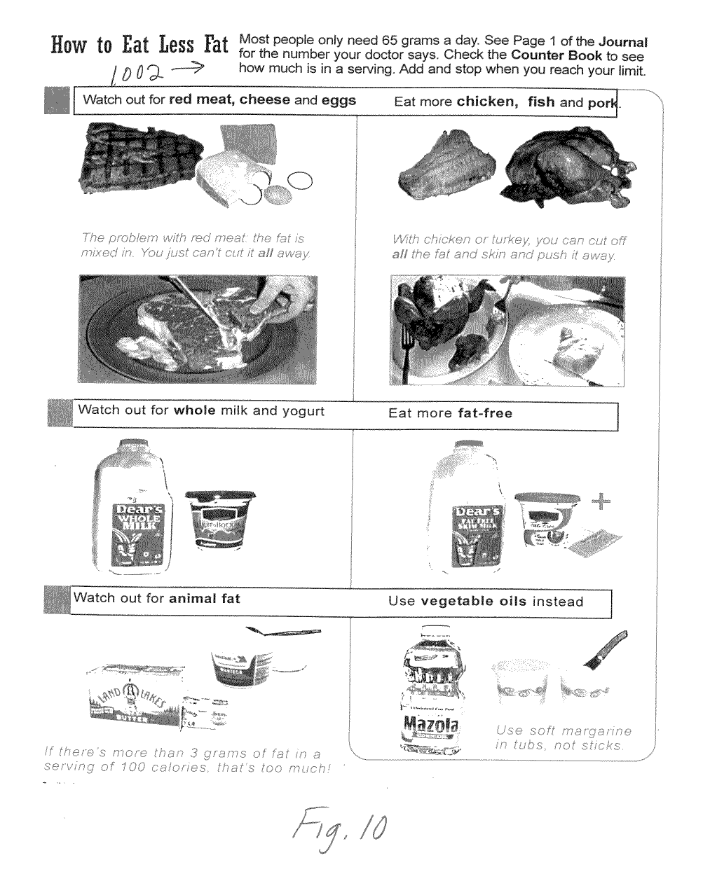

FIG. 10 illustrates instructions on how to eat less fat 1002. The instructions 1002 inform the user to eat less red meat (and less cheese and eggs) and to eat more chicken, fish, and pork because much of the fat cannot be removed from red meat prior to consumption like the fat on chicken, fish, and pork. Similarly, the instructions 1002 inform the user to avoid whole milk, yogurt, and butter in favor of skim milk, fat free yogurt, and margarine. As a rule of thumb, the instructions 1002 indicate that if a food contains more than three grams of fat in a one-hundred calorie serving, the food contains too much fat.

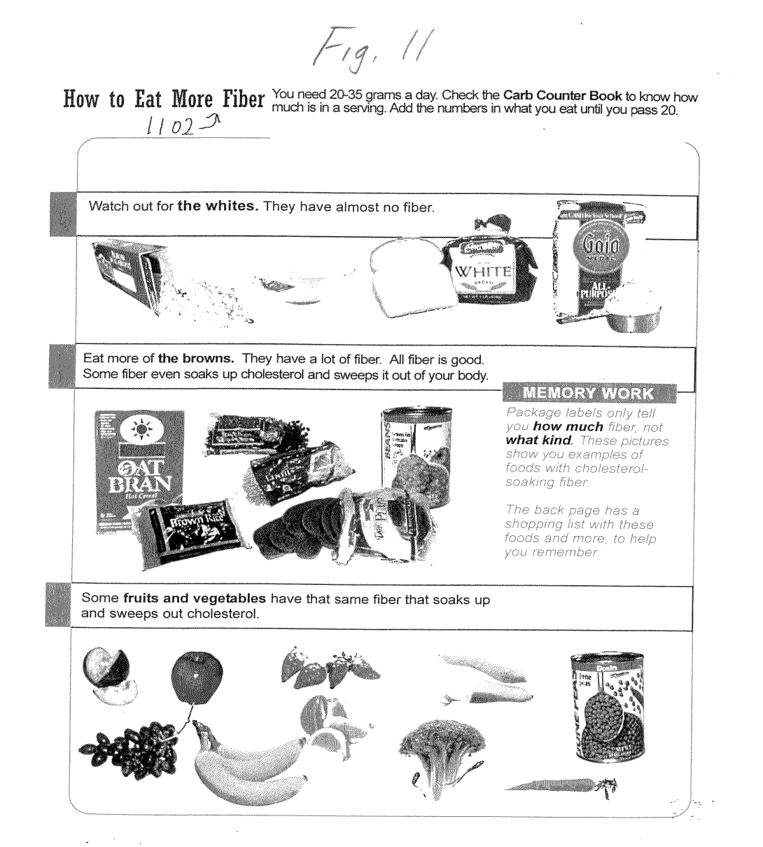

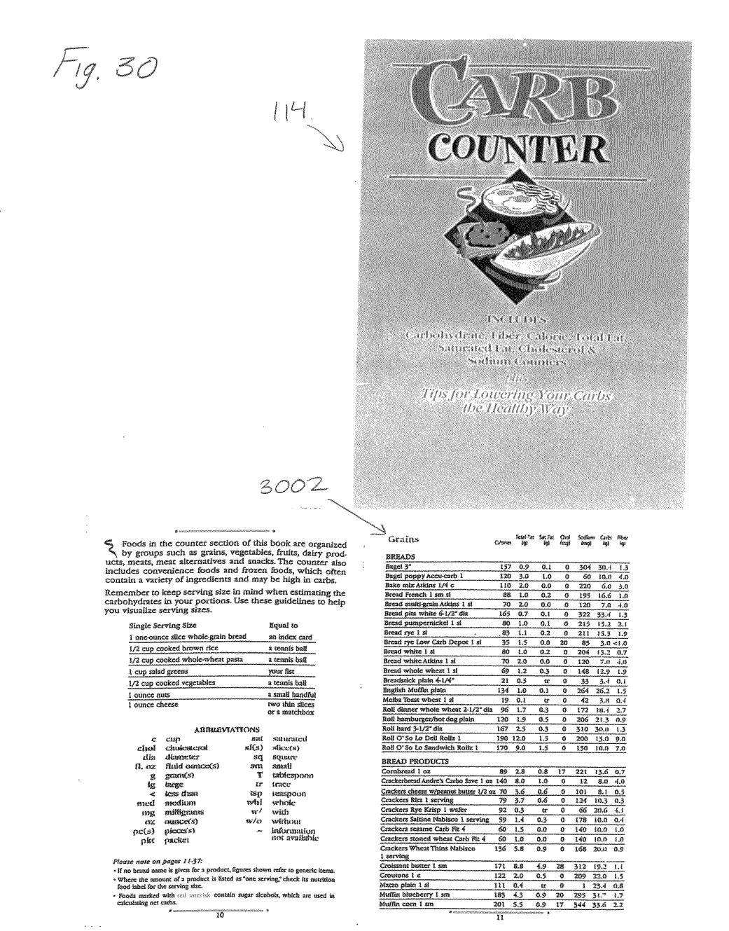

FIG. 11 illustrates instructions on how to eat more fiber 1102. The instructions 1102 inform the user to consume between twenty and thirty-five grams of carbohydrates each day. The carbohydrate counting book 114 is included with the system 100 to help the user reach this goal. Carbohydrate counting book 114 is illustrated in FIG. 30. The instructions 1102 inform the user to eat less white fibers such as pasta, white rice, white bread, and white flour and to eat more brown fibers such as oat bran, brown rice, wheat bread, and beans. The instructions 1102 indicate that some fiber, such as fiber found in certain fruits, helps to reduce cholesterol. However, most food labels only indicate the amount of fiber, not the type of fiber. Accordingly, the instructions remind the user to remember which foods have a cholesterol soaking type of fiber, and/or to bring the shopping list 1204 included with the system 100 with them to the store.

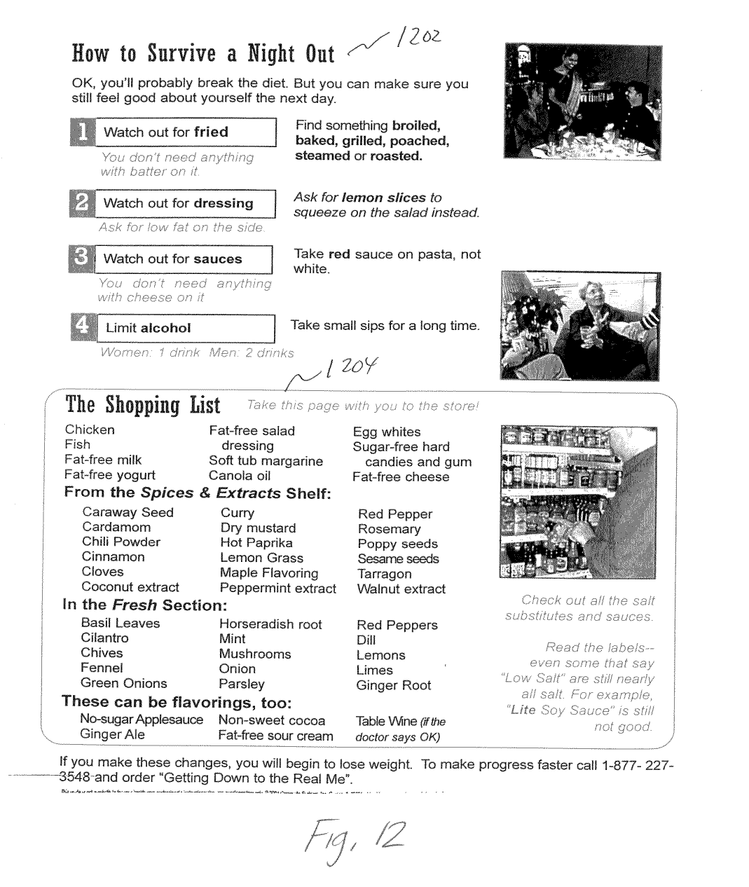

FIG. 12 illustrates instructions on how to survive a night eating out 1202. The instructions 1202 list several types of food to avoid and healthier alternatives to those foods. For example, instead of fried foods and/or foods with a batter, the instructions 1202 suggest foods that are broiled, baked, grilled, poached, steamed, or roasted. Instead of regular salad dressing on a salad, the instructions 1202 suggest low fat salad dressing on the side or lemon juice squeezed from a lemon slice. Instead of white pasta sauce and/or cheese, the instructions 1202 suggest red pasta sauce. In addition, the instructions 1202 suggest slowing down alcohol consumption by taking small sips over a long period of time and limiting alcohol consumption to one drink for women and two drinks for men. The instructions 1202 also include a suggested shopping list 1204 to take to the grocery store. The suggested shopping list 1204 includes a list of healthy foods.

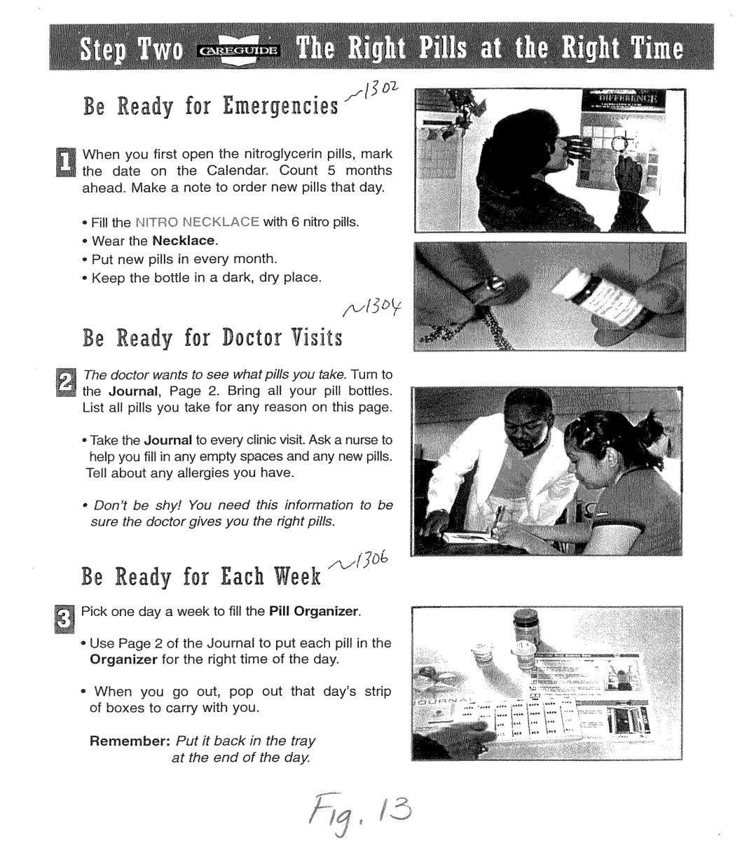

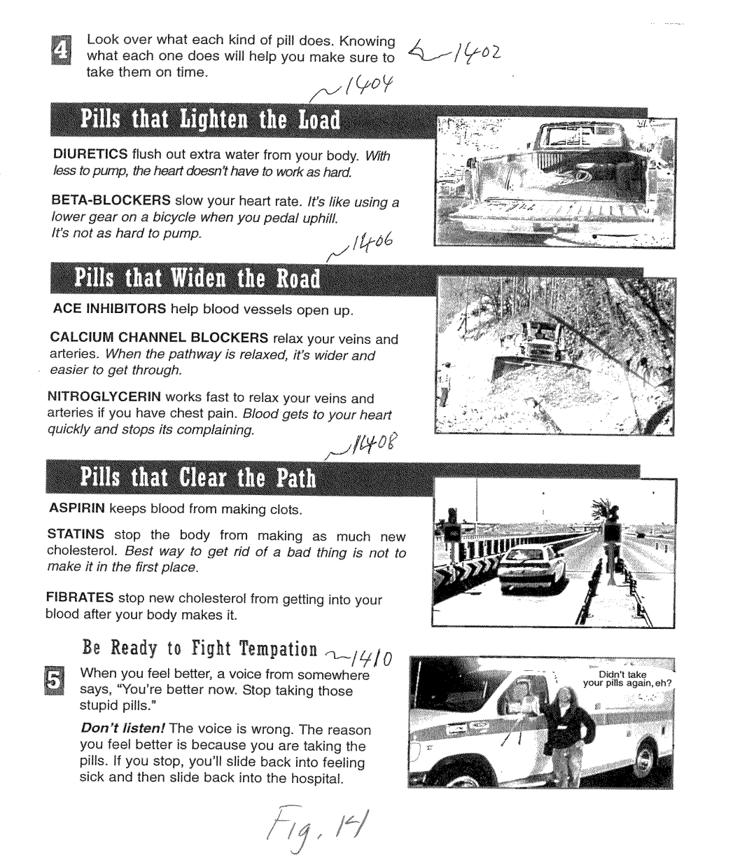

FIG. 13 and FIG. 14 illustrate a secondary step-by-step guide 1300 for the take-the-right-pills step 710 (i.e., the second step). The secondary step-by-step guide 1300 includes instructions on being ready for emergencies 1302, being ready for doctor visits 1304, being ready for each week 1306, knowing the function of different medications 1402, and being ready to fight temptation 1404.

FIG. 13 illustrates instructions on being ready for emergencies 1302. The instructions 1302 inform the user to mark a calendar as a reminder to reorder nitroglycerin pills (e.g., five months after a new container is opened). In addition, the instructions 1302 instruct the user to fill the nitroglycerin dispenser 120 (e.g., a nitroglycerin necklace) with nitroglycerin pills (e.g., six ) and to wear the nitroglycerin dispenser 120. According to the instructions 1302, the nitroglycerin dispenser 120 should be refilled (if needed) every month and the bottle should be kept in a dark, dry place.

FIG. 13 also illustrates instructions on being ready for doctor visits 1304. The instructions 1304 inform the user to record medication consumption in the record book 104 and to bring the record book 104 and the user's medication containers to each doctor visit. In this manner, the doctor can review the record book 104 and medication containers to determine if the right medications are being taken in the right quantities and frequencies.

FIG. 13 also illustrates instructions on being ready for each week 1306. The instructions 1306 inform the user to pick one day a week (e.g., every Monday) to fill the pill organizer 118. The record book 104 may be used to ensure the correct pills are put into the pill organizer 118 in a way that corresponds to the right time of day for each pill to be taken. A portion of the pill organizer 118 corresponding to four time periods for each day (e.g., morning, noon, evening, bedtime) may be removed from the pill organizer 118 at the beginning of each day and replaced each night.

FIG. 14 illustrates instructions on knowing the function of different medications 1402. The instructions 1402 inform the user about the pills that lighten the load 1404 for the heart, pills that widen the road 1406 for blood flow, and pills that clear the path 1408 for blood flow.

Examples of pills (or other forms of medication) that lighten the load 1404 for the heart include diuretics and beta-blockers. Diuretics flush out extra water from the body. With less fluid to pump, the heart does not have to work as hard. Beta-blockers reduce a person's heart rate. The instructions liken this to using a lower gear on a bicycle to pedal uphill.

Examples of pills (or other forms of medication) that widen the road 1406 for blood flow include ace inhibitors, calcium channel blockers, and nitroglycerin. Ace inhibitors facilitate the opening of blood vessels. Calcium channel blockers relax a person's veins and arteries, which makes the veins and arteries wider and easier for blood to pass through. Nitroglycerin works quickly to relax a person's veins and arteries. Nitroglycerin is especially helpful to reduce chest pain by getting blood to the heart quickly.

Examples of pills (or other forms of medication) that clear the path 1408 for blood flow include aspirin, statins, and fibrates, Aspirin keeps blood from clotting. Statins reduce the amount of cholesterol the body produces. Fibrates reduce the amount of cholesterol that gets into the blood stream.

FIG. 14 also illustrates instructions on being ready to fight temptation 1404. The instructions 1404 inform the user that feeling better is not a reason to stop taking medications. On the contrary, the reason the person is feeling better is because he/she is taking the medications. A cycle that some people enter is to stop taking medications when they feel better only to wind up back in the hospital.

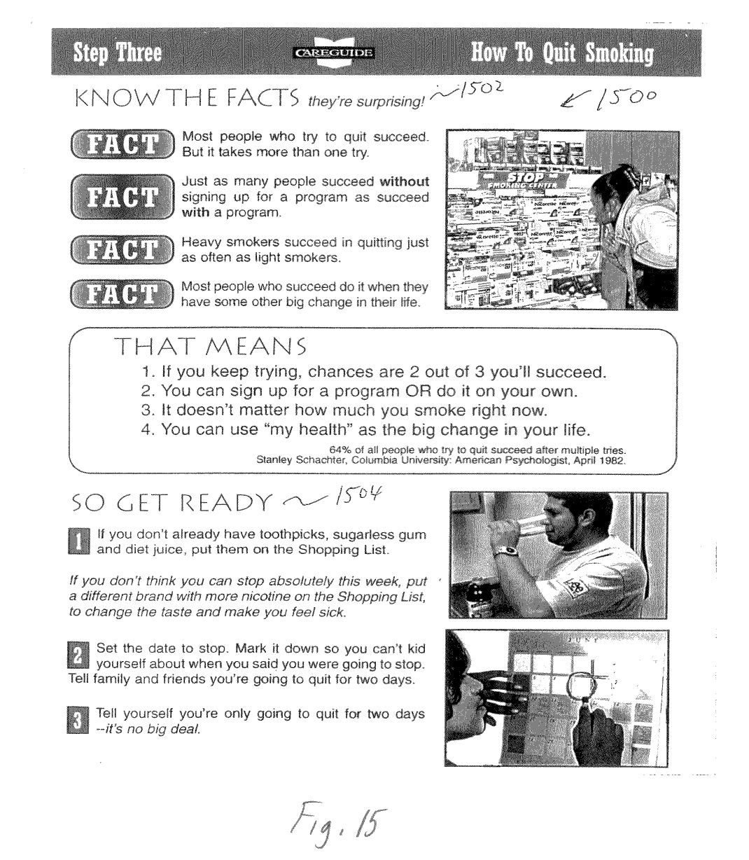

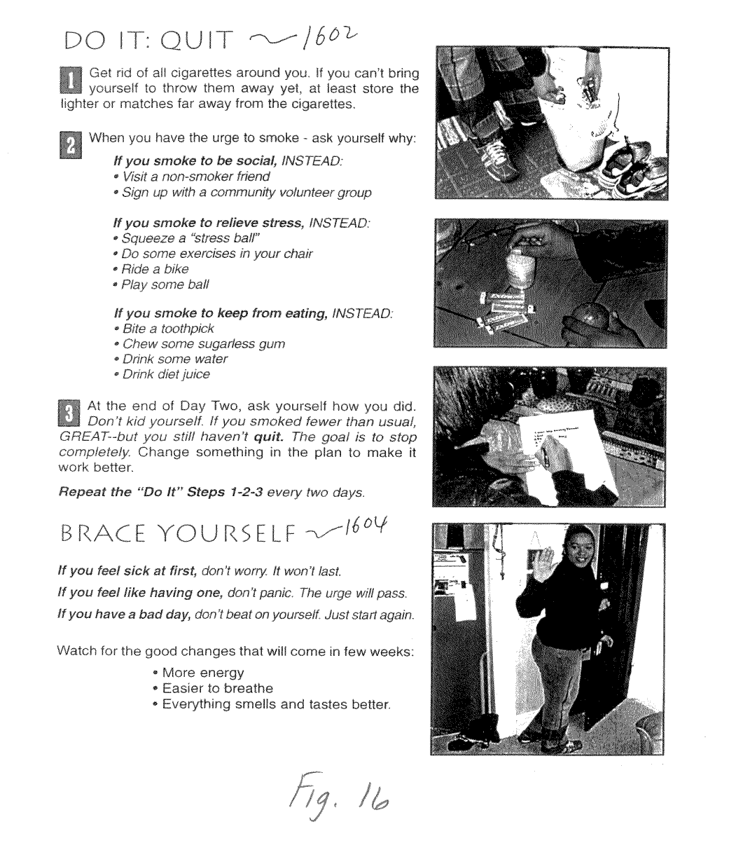

FIG. 15 and FIG. 16 illustrate a secondary step-by-step guide 1500 for the stop smoking step 712 (i.e., the third step). The secondary step-by-step guide 1500 includes facts about quitting smoking 1502, instructions on preparing to quit smoking 1504, instructions on quitting smoking 1602, and instructions on preparing for the effects of quitting smoking 1604.

FIG. 15 illustrates facts about quitting smoking 1502. The facts 1502 informs the user that most people who attempt to quit smoking succeed. However, quitting may take more than one attempt. In fact, about two thirds of people who try to quit succeed after multiple attempts. The facts 1502 also inform the user that just as many people succeed in quitting smoking without signing up for a program as those who succeed with a program. The facts 1502 also inform the user that heavy smokers succeed in quitting just as often as light smokers. So, it does not matter how much the person currently smokes. The facts 1502 also inform the user that most people who successfully quit smoking quit when they have some other big change in their life. For example, beginning to use the system 100 may be the big change.

FIG. 15 also illustrates instructions on preparing to quit smoking 1504. The instructions 1504 instruct the user to add toothpicks, sugarless gum, and diet juice to the person's grocery shopping list. In addition, the instructions 1504 suggest that if the person does not feel that he/she can stop smoking right away, to switch to a brand of cigarettes that contain more nicotine to change the taste associated with smoking and make the person feel sick. The instructions 1504 also tell the user to pick a date to stop smoking completely and to mark that date on their calendar. The instructions 1504 also instruct the user to tell friends and family (and himself/herself) that he/she only intends to quit for two days (i.e., that quitting is not a big deal).

FIG. 16 illustrates instructions on quitting smoking 1602. The instructions 1602 instruct the user to dispose of all cigarettes. Alternatively, the user may store any existing cigarettes in a separate place, away from lighters and matches. When the urge to smoke occurs, the instructions 1602 have the user ask himself/herself why they smoke. If the user smokes to be social, the instructions 1602 suggest visiting a non-smoking friend and/or joining a community volunteer group. If the user smokes to relieve stress, the instructions 1602 suggest squeezing a stress ball, doing some exercises (e.g., in the user's chair at work and/or at home), riding a bike, and/or playing a sport. If the user smokes to keep from eating, the instructions 1602 suggest biting on a toothpick, chewing sugarless gum, drinking some water, and/or drinking diet juice. After two days, the user performs a self-assessment and makes any adjustments that are needed to quit smoking.

FIG. 16 also illustrates instructions on preparing for the effects of quitting smoking 1604. The instructions 1604 inform the user that if he/she feels sick, not to worry because the feeling will pass. The instructions 1604 also inform the user that if the user feels the urge to have a cigarette, not to panic because the urge will pass. The instructions 1604 also inform the user that if the user has a bad day, not to worry and to just start the program over again. The instructions 1604 encourage the user by informing the user that by quitting smoking, the user should notice several positive benefits such as having more energy, having an easier time breathing, and that things will smell and taste better.

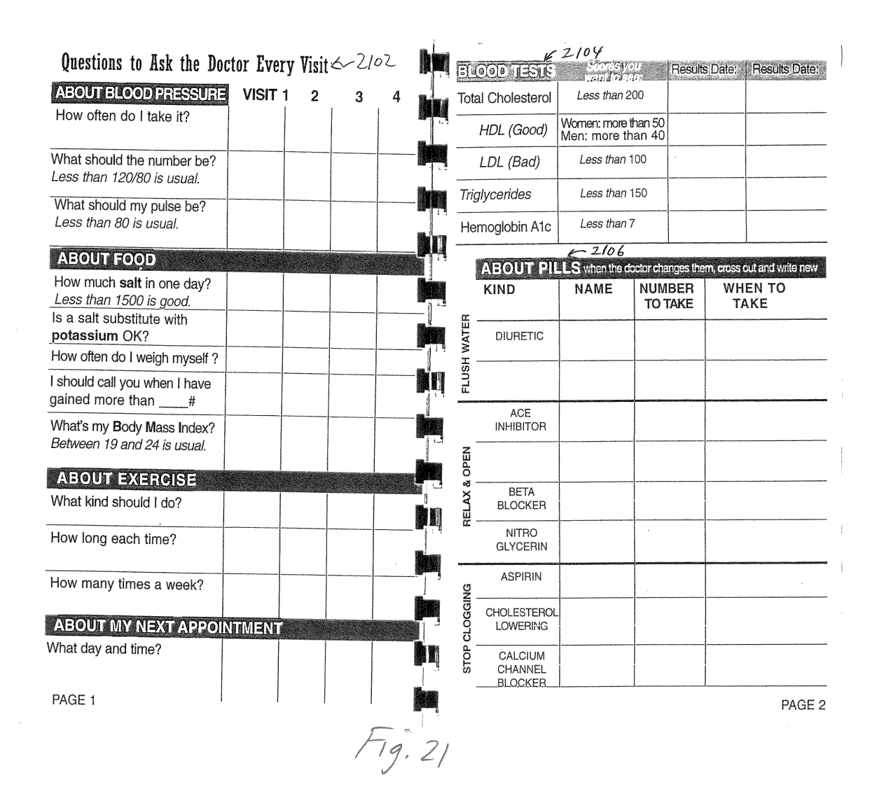

FIG. 21 illustrates a secondary step-by-step guide 112 for stress management. The stress management guide includes an explanation of how to recognize stress 1710 and ways to manage stress such as breathing exercises 1720, stretching exercises 1730, and actions to avoid stress 1740, and how to rate stress 1750.

The explanation of how to recognize stress 1710 informs the user that everyone experiences some stress. Stress is the body's natural reaction to tension, pressure, and/or change. Small amounts of stress make life more interesting and less boring. However, excess stress, especially prolonged and unrelieved stress, can be mentally and physically unhealthy. The stress management guide includes a listing of signs of stress 1710 such as headaches, upset stomach, hopeless feelings, etc. Many of these symptoms may also be caused by medical conditions, but the guide points out that effective management of the stress may improve health. In addition, the stress management guide may include a scale on which to rate the stress of the user at a particular time 1750.

The guide 160 includes anti-stress exercises such as breathing exercises 1720 and stretching exercises 1730. For example, the breathing exercises may include closing eyes, and breathing in or out for periods of time while moving certain parts of the body such as the shoulders. The stretching exercises may include a finger fan exercise, an upper back stretch, an ear-to-shoulder exercise, an overhead reach exercise, a knee-pull exercise, and a waist-bend exercise. The finger fan exercise includes extending the arms and spreading the fingers. The upper back stretch includes sitting up straight with the fingers interlocked behind the head and bring the elbows back. The ear-to-shoulder exercise includes lowering the ear to the shoulder. The overhead reach exercise includes raising the arms over the head with interlaced fingers. The knee-pull exercise includes pulling one knee at a time up to the chest in a seated position. The waist-bend exercise includes bending from side-to-side at the waist with the arms extended over the head.

The instructions on ways to manage stress 1740 include actions such as thinking positively and being around other positive people, avoiding being overly demanding on oneself and getting help when needed, writing and following a reasonable to do list each day, dividing big tasks into smaller more manageable tasks, eating a healthier diet, minimizing and/or eliminating consumption of coffee and sugar, getting plenty of sleep, getting enough exercise, making time to relax, avoiding tobacco, alcohol, and drugs, using mistakes and setbacks as opportunities to learn, avoiding high stress tasks, talking to a friend about disappointments and frustration before they build up and sharing your successes, admitting when you are wrong, eliminating everyday sources of stress such as loud music and clutter, having fun and laugh, knowing it is okay to cry, practicing deep breathing, being active during everyday tasks such as taking the stairs instead of the elevator and/or not sitting when talking on the telephone, and doing anti-stress stretches every day.

The stress management guide may include other examples of how to act in response to stressful circumstances 1740 such as those listed in FIG. 21: if you have a negative neighbor, walk away, if a task is too big, break it down and get help; if the stakes are too high, get feedback early; if lonely, volunteer; if sad, get a pet; if nervous, cut out coffee and sugar; if a mistake is made, admit it and move on; if no time, say no and suggest someone else; if frowning, enjoy some comedy; if feeling stuck, walk around, outside if possible; if overwhelmed, make a “to do” list. These and other such examples may be included in the stress management guide.

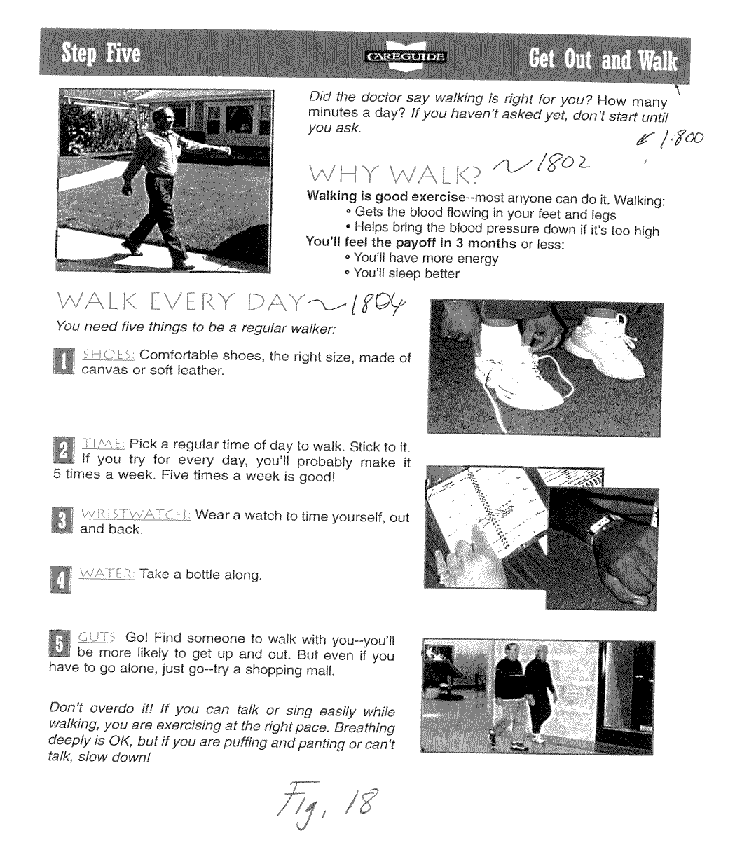

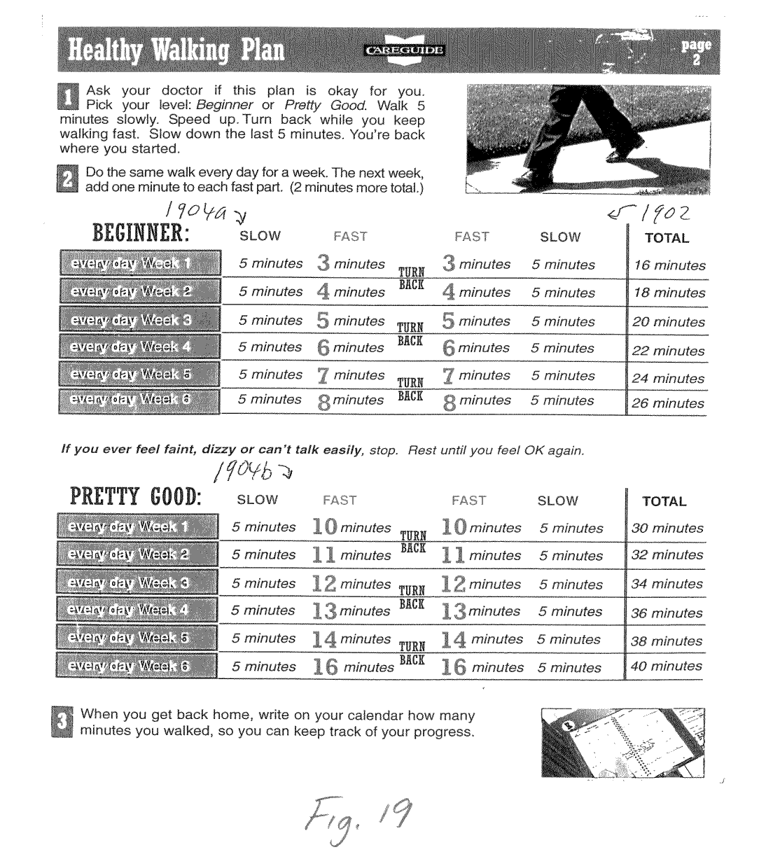

FIG. 18 and FIG. 19 illustrate a secondary step-by-step guide 1800 for the get-moving step 716 (i.e., the fifth step). The secondary step-by-step guide 1800 includes instructions on why people should walk 1802, things people need to be a regular walker 1804, and a healthy walking plan 1902.

FIG. 18 illustrates instructions on why people should walk 1802. The instructions 1802 inform the user that walking is good exercise that almost anyone can do. The instructions 1802 indicate that walking is good exercise because walking gets the blood flowing in the feet and legs. Walking also helps reduce high blood pressure. After several months of regular walking, the user can expect to have more energy and sleep better.

FIG. 18 also illustrates instructions on things people need to be a regular walker 1804. The instructions 1804 indicate that the user should have walking shoes, a regular walking time, a watch, water, and guts. The walking shoes should be the right size, comfortable, and made of canvas or soft leather. The user should try to stick to the regular walking time seven days per week and be happy with sticking to the walking routine at least five times per week. The instructions 1804 also indicate that the user may want to find a friend to walk with. In this manner, the user may be more likely to stick to the walking commitment. Other suggestions included in the sample instructions 1804 include walking at a mall, not over-doing the walking routine, and walking at a pace where talking is still comfortable.

FIG. 19 illustrates instructions on the healthy walking plan 1902. Two different walking schedules 1904a and 1904b are presented. The first walking schedule 1904a is directed to beginning walkers. The second walking schedule 1904b is directed to more advanced walkers. Each walking schedule 1904a and 1904b includes a number of minutes to walk slow (e.g., a warm up and/or a cool down) and a number of minutes to walk fast each day for a week. For example, the instructions 1902 tell first week beginning walkers to walk slow for five minutes (i.e., warm up), then fast for three minutes, then to turn around and walk another three minutes, fast in the opposite direction, and another five minutes, slow (i.e., cool down). This returns the walker to where they began. The number of fast minutes is then increased each week. For example, the instructions 1902 tell walkers beginning their second week to walk fast for four minutes in each direction (i.e., increase by two minutes total) and to do the same five minute warm-up and five minute cool-down. The instructions 1902 also instruct the user to record the number of minutes walked each day and to ask his/her doctor to approve the walking plan.

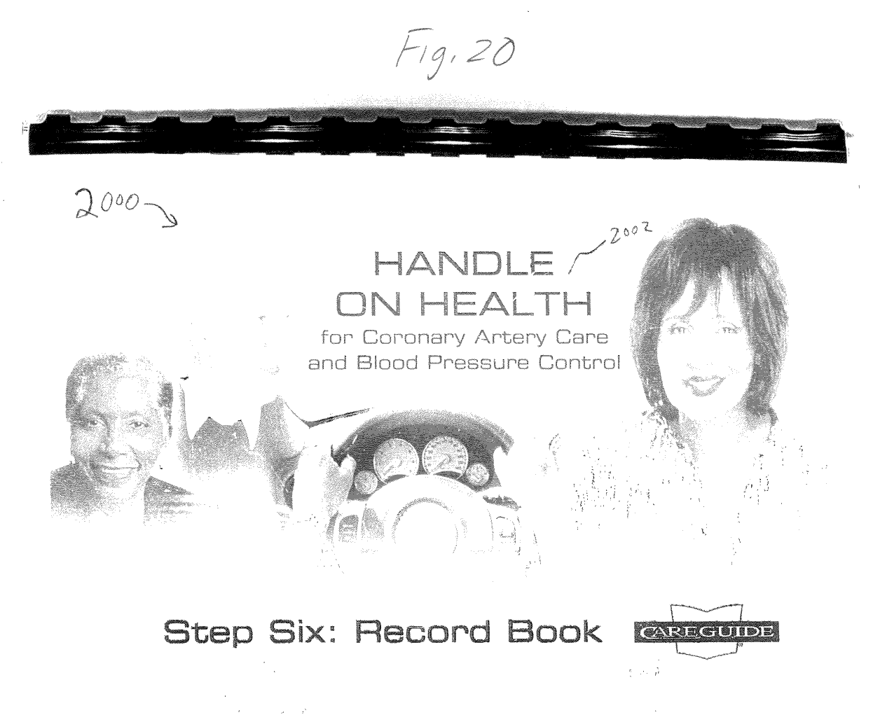

FIG. 20 through FIG. 23 illustrate a secondary step-by-step guide 2000 for the keep-a-record step 718 (i.e., the sixth step). The secondary step-by-step guide 2000 includes a cover 2002, a place to record questions for the doctor 2102, a place to record blood test results 2104, a place to record information about medications 2106, instructions on how to keep the medical records 2202, and a plurality of weekly record pages 2302.

FIG. 21 illustrates a place to record questions for the doctor 2102. The record keeping book 104 includes questions about blood pressure, food, exercise, and the next appointment. For example, the questions (and associated blanks) about blood pressure may include a question on how often to take a blood pressure reading, what the blood pressure number should be, and/or what a pulse reading should be. The questions (and associated blanks) about food may include a question on how much salt should be consumed each day, if potassium is an acceptable salt substitute, how often the user should weigh themselves, what level of weight gain warrants a call to the doctor, and/or the user's body mass index. The questions (and associated blanks) about exercise may include a question on what type of exercises the user should be doing, how long the user should be exercising, and/or how often the user should be exercising. The questions (and associated blanks) about the next appointment may include the date and/or time of the next appointment.

FIG. 21 also illustrates a place to record blood test results 2104. The record keeping book 104 includes a place to record a total cholesterol test result, a high density cholesterol (HDL) test result, a low density cholesterol (LDL) test result, a triglycerides test result, and a hemoglobin A1c test result. For each of the blood test types, the record keeping book 104 includes a target score (e.g., less than 200 for total cholesterol), a blank for a test date, and a blank for a test score.

FIG. 21 also illustrates a place to record information about medications 2106. The record keeping book 104 includes a place to record information about a diuretic, an ace inhibitor, a beta blocker a nitroglycerin pill, an aspirin, a cholesterol lowering medication, a calcium channel blocker, vitamins, and other medications. For each of the medications, the record keeping book 104 includes a blank for a name of the medication, a dosage, (e.g., number of pills to take), and when to take the medication (e.g., twice a day). Preferably, the medications are grouped by the function they perform. In this example, the groups include medications that flush water out of the arteries, medications that relax and open arteries, medications that prevent artery clogging, and other medications.

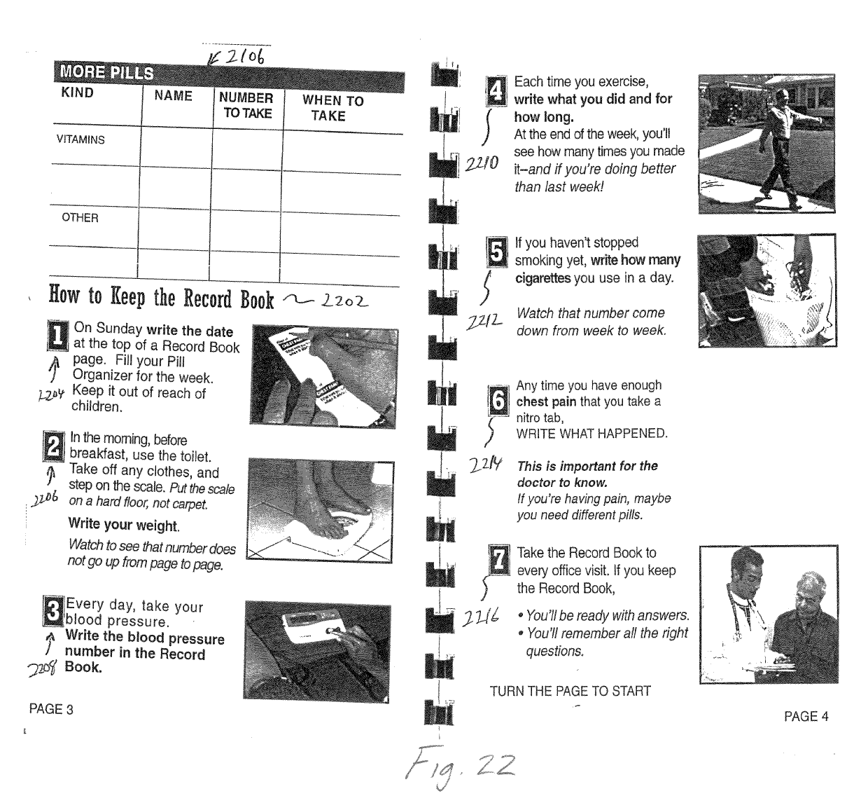

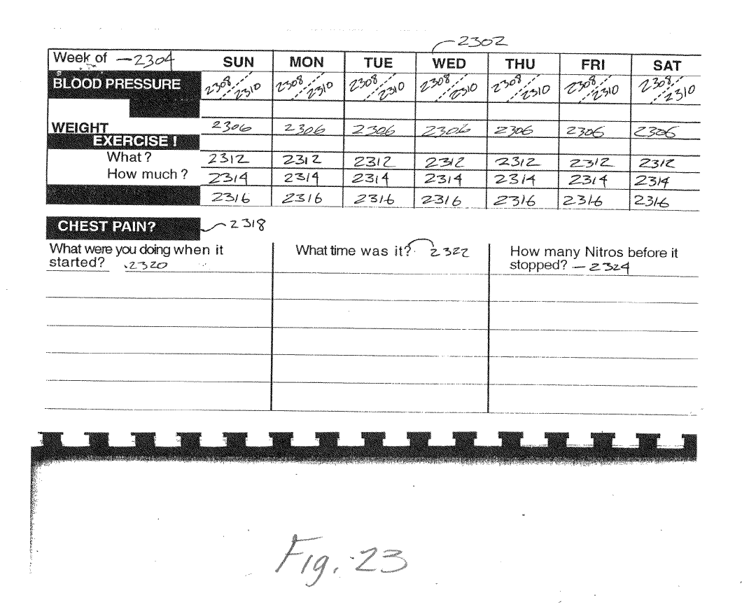

FIG. 22 illustrates instructions on how to keep the medical records 2202, and FIG. 23 illustrates one example of a plurality of weekly record pages 2302. In this example, a first step 2204 of the instructions 2202 tell the user to write the date at the top 2304 of a blank weekly record page 2302 each Sunday. In addition, the instructions 2202 tell the user to fill the pill organizer 118 for the week and to keep the pill organizer 118 out of reach of children.

A second step 2206 of the medical record keeping instructions 2202 tells the user to weigh himself/herself each morning before breakfast and after using the toilet. The instructions 2202 indicate that the user should place the scale on a hard floor (not carpeting) and to remove any clothing before weighing. The weight is then recorded in a blank 2306 corresponding to the current day on the weekly record page 2302. The instructions 2202 also tell the user to watch this recorded weight to make sure that the weight does not change (e.g., go up over time).

A third step 2208 of the medical record keeping instructions 2202 tells the user to take his/her blood pressure every day and to record the blood pressure in the record book 104. The blood pressure may be recorded each day in two blanks 2308 and 2310 on the weekly record page 2302. The first blank 2308 is for recording blood pressure during the heart's pushing state, and the second blank 2310 is for recording blood pressure during the heart's resting state. A digital blood pressure monitor 102 is included in the system 100 for measuring blood pressure, and instructions 116 for using the blood pressure monitor 102 are described below.

A fourth step 2210 of the medical record keeping instructions 2202 tells the user to record what types of exercises he/she performed and how long each exercise was performed. The type of exercise may be recorded each day in one blank 2312 on the weekly record page 2302, and the amount of exercise may be recorded each day in another blank 2314 on the weekly record page 2302. By recording the type and amount of exercise performed on various days of the week, the user is able to track progress from week to week.

A fifth step 2212 of the medical record keeping instructions 2202 tells the user to record the number of cigarettes he/she smokes each day (if any). In this example, the number of cigarettes smoked may be recorded each day in a blank 2316 on the weekly record page 2302. By recording the number of cigarettes smoked each day, the user is able to track progress from week to week.

A sixth step 2214 of the medical record keeping instructions 2202 tells the user to record what happens each time the user experiences chest pain and takes a nitroglycerin tablet. The chest pain information may be recorded in a section 2318 of the weekly record page 2302. This section 2318 includes a portion 2320 to record what the user was doing when the chest pain started, a portion 2322 to record the date and/or time the chest pain occurred, and/or a portion 2324 to record how many nitroglycerin tablets were needed to stop the chest pain. The doctor may use the chest pain information to prescribe different medication for the chest pain.

A seventh step 2216 of the medical record keeping instructions 2202 tells the user to bring the record book 104 to each doctor visit. In this manner, the user will be ready with answers to questions posed by the doctor. In addition, the user will remember to ask the doctor certain questions.

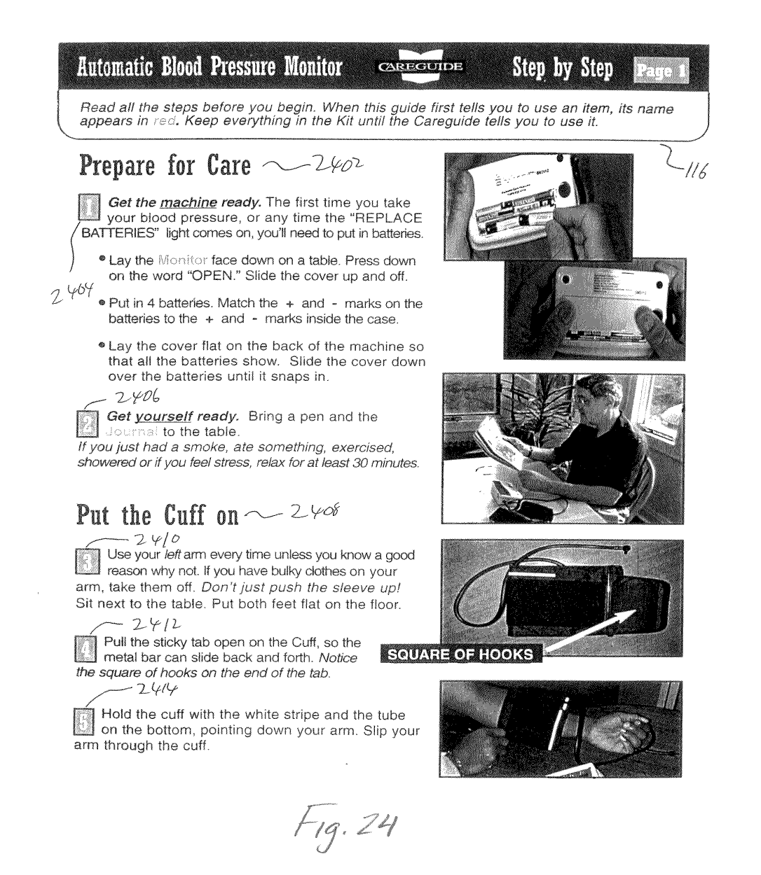

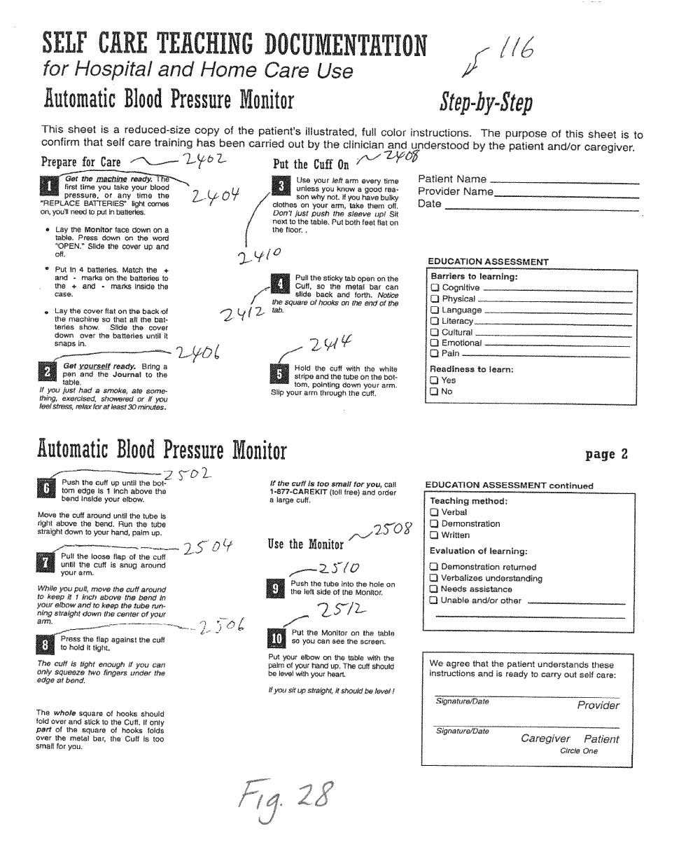

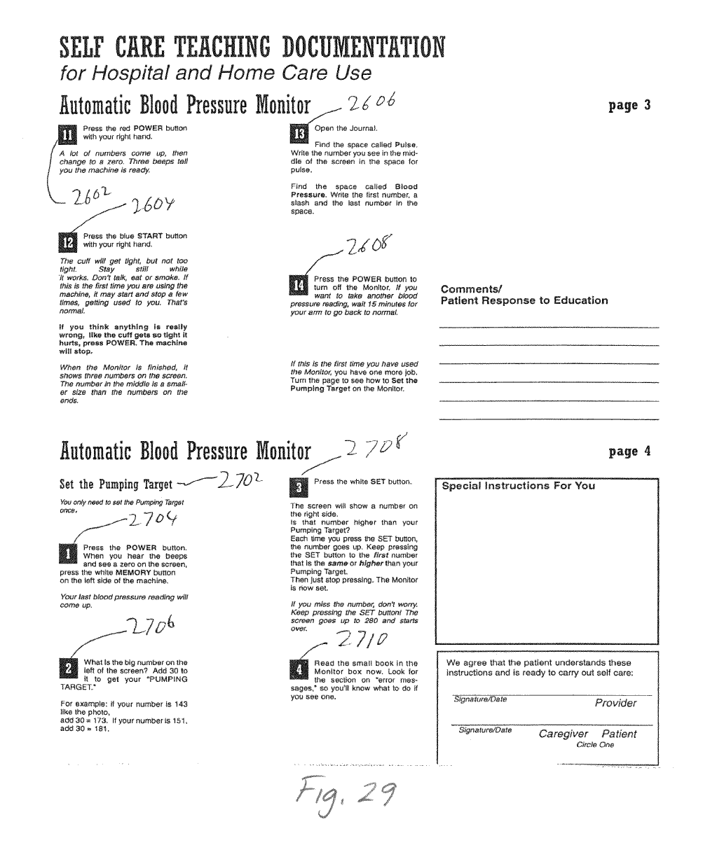

Instructions 116 for the blood pressure monitor 102 are illustrated in FIG. 24 to FIG. 27. A reduced-size copy of the blood pressure monitor instructions 116 are illustrated in FIG. 28 and FIG. 29. The reduced-size copy of the instructions 116 may be used as a checklist by trainer to confirm that the user is familiar with the use of the blood pressure monitor 102.

The blood pressure monitor 102 may be any type of suitable blood pressure monitor 102. For example, the blood pressure monitor 102 may be a manual blood pressure monitor 102 or an automatic blood pressure monitor 102. A manual blood pressure monitor 102 must be manually pumped (e.g., by hand). The instructions 116 are for an automatic blood pressure monitor 102 which pumps automatically. The instructions 116 indicate that the first time the user is instructed to use a particular item, the name of that item appears in red.

A first section 2402 of the blood pressure monitor instructions 116 tells the user how to prepare for a blood pressure reading. A first step 2404 tells the user to prepare the blood pressure monitor 102 for use by inserting fresh batteries. A second step 2406 tells the user to have a writing instrument and the medical record book 104 handy. In addition, the second step 2406 tells the user to relax for thirty minutes if he/she just smoked a cigarette, ate something, exercised, showered, or feels stressed.

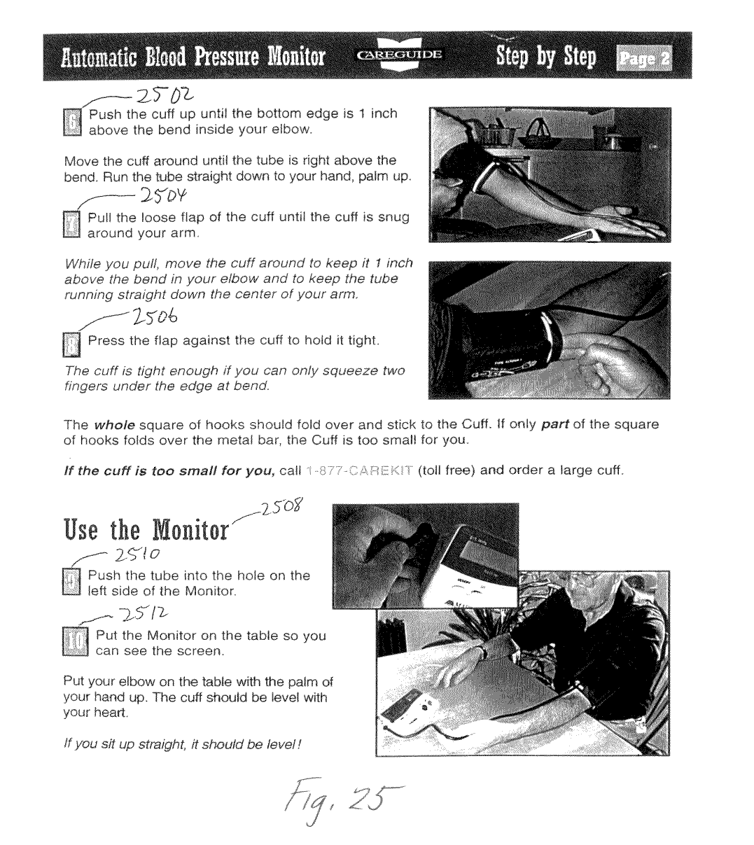

A second section 2408 of the blood pressure monitor instructions 116 tells the user how to put the cuff on his/her arm. A third step 2410 tells the user to use the left arm (unless there is a good reason not to), remove bulky clothing, and to sit next to a table with both feet flat on the floor. A fourth step 2412 tells the user to pull open the sticky tab (e.g., velcro tab) on the cuff, so a metal bar can slide back and forth. A fifth step 2414 tells the user to slip his/her arm through the cuff while holding the cuff with the white strip and the tube on the bottom, pointing down the user's arm. Turning to FIG. 25, a sixth step 2502 tells the user to push the cuff up until the bottom edge of the cuff is about one inch above the bend inside the user's elbow. A seventh step 2504 tells the user to pull the loose flap against the cuff until the cuff is snug around the user's arm. An eighth step 2506 tells the user to press the flap against the cuff to hold the cuff tight.

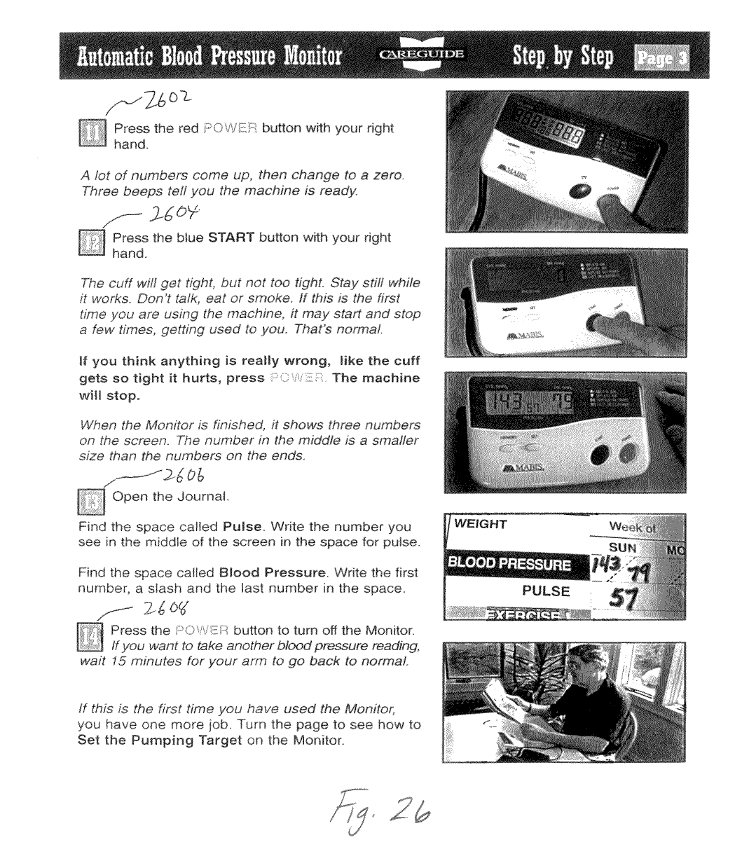

A third section 2508 of the blood pressure monitor instructions 116 tells the user how to use the blood pressure monitor 102. A ninth step 2510 tells the user to push the tube into the hole on the left side of the monitor. A tenth step 2512 tells the user to place the blood pressure monitor 102 on the table where the display can be seen and to put the user's elbow on the table with the palm up and the cuff level with the user's heart. Turning to FIG. 26, an eleventh step 2602 tells the user to press the red power button on the blood pressure monitor 102 with the user's right hand. A twelfth step 2604 tells the user to press the blue start button on the blood pressure monitor 102 with the user's right hand. The twelfth step 2604 also explains that the cuff will tighten and explains how to read the numbers from the blood pressure monitor 102. A thirteenth step 2606 tells the user how to record the pulse and blood pressure readings in the medical record book 104. A fourteenth step 2608 tells the user to press the red power button again to turn the blood pressure monitor 102 off.

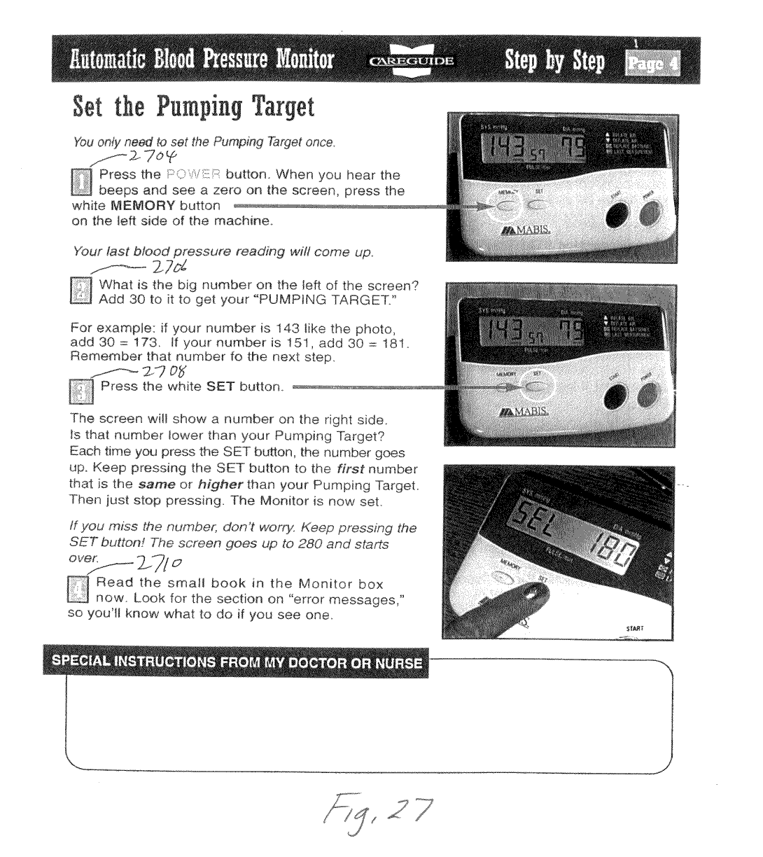

Turning to FIG. 27, a fourth section 2702 of the blood pressure monitor instructions 116 tells the user how to set a pumping target on the blood pressure monitor 102. Typically, setting the pumping target only needs to be performed after the first use of the blood pressure monitor 102. A first step 2704 tells the user to turn the blood pressure monitor 102 on and press the white memory button. Pressing the memory button brings up the user's last blood pressure reading. A second step 2706 tells the user to calculate the user's actual pumping target by adding thirty to the last blood pressure reading. For example, if the last blood pressure reading was 143, adding thirty results in an actual pumping target of 173. A third step 2708 tells the user to press the set button and check the set target number that appears on the right hand side of the screen. If the set target number is lower than the actual pumping target, then the user is instructed to keep pressing the set button until the set target number reaches or exceeds (for the first time) the actual pumping target. A fourth step 2710 tells the user to consult a list of error messages to further familiarize the user with the blood pressure monitor 102. The blood pressure monitor instructions 116 also include a blank portion 2712 where the user may record any special instructions from his/her doctor about the blood pressure monitor 102 and/or taking the blood pressure readings.

FIG. 30 illustrates a carbohydrate counting book 114. The carbohydrate counting book 114 includes the amount of carbohydrates, fiber, calories, total fat, saturated fat, cholesterol, and sodium in a plurality of different foods. The foods are organized by groups such as grains, vegetables, fruits, dairy products, meats, meat alternatives, snacks, convenience foods, frozen foods, etc. Only one page 3002 of foods is shown in this example. However, it will be appreciated that a plurality of food pages are preferably included in the carbohydrate counting book 114.

By using the carbohydrate counting book 114, the user may begin to include more fiber in his/her diet per the instructions in the system 100. In addition, the system 100 encourages the user to eat less white fibers such as pasta, white rice, white bread, and white flour and to eat more brown fibers such as oat bran, brown rice, wheat bread, and beans. Information on all of these foods may be looked up in the carbohydrate counting book 114. Further, some fiber, such as fiber found in certain fruits, helps to reduce cholesterol. However, most food labels only indicate the amount of fiber, not the type of fiber. Accordingly, the user may consult the carbohydrate counting book 114 to determine which foods have the cholesterol soaking type of fiber.

It should be appreciated that the disclosed integrated system or any elements thereof may be provided in any suitable sensory form and on any suitable medium and combinations thereof. For example, any element of the disclosed integrated system may be provided in audio, visual, or tactile form such as Braille. Any element of the disclosed integrated system may be provided on paper, on any suitable machine or computer readable form such as cd-rom, dvd, or any other suitable physical or electronic medium.

It should be appreciated that the system, apparatus and method disclosed herein provides an easy to understand and remember method for better enabling the user to understand why they need to do certain things and how things are related, (b) instructions which integrate the care for multiple medical conditions, and (c) integrated directions on meal planning and other activities for multiple medical conditions, all without overlapping or contrary instructions. The system and apparatus are thus configured to enable a user to simultaneously provide integrated self care for multiple different medical conditions including high blood pressure and coronary artery disease.

In summary, methods and apparatus for blood pressure control and coronary artery care have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

The invention is claimed as follows:

1. An integrated blood pressure control and coronary artery care self care system, the system comprising:
a magnet board, the magnet board including a portion to write a telephone number and a label indicating the telephone number is a doctor's telephone number;
a blood pressure monitor;
a pill organizer;
a nitroglycerin dispenser;
a stress management guide;
a primary step-by-step guide, the primary step-by-step guide including a plurality of primary steps associated with blood and arteries including at least three of:
(1) a dietary program,
(2) a medicine compliance program,
(3) a tobacco addiction program,
(4) a stress management program,
(5) an exercise program, and
(6) a medical record keeping program; and
at least one secondary step-by-step guide, the secondary step-by-step guide including a plurality of secondary steps associated with at least one of the primary steps; and
a container for storing the above components.

2. The system of claim 1, wherein the blood pressure monitor includes a digital blood pressure monitor.

3. The system of claim 1, including a set of blood pressure monitor instructions, the blood pressure monitor instructions including at least three of:
(a) at least one instruction for getting the blood pressure monitor ready for use,
(b) at least one instruction for getting a user prepared,
(c) at least one instruction for attaching a cuff of the blood pressure monitor to the user, and
(d) at least one instruction for operating the blood pressure monitor.

4. The system of claim 1, wherein the pill organizer includes a twenty-eight dose pill organizer.

5. The system of claim 1, wherein the twenty-eight dose pill organizer includes: four compartments for each of seven days of a week, and
labels indicative of each of the seven days and four time periods during each of the seven days.

6. The system of claim 1, wherein the nitroglycerin dispenser includes a necklace.

7. The system of claim 1, wherein the stress management guide includes a stress management pocket pal.

8. The system of claim 1, wherein the primary steps of the primary step-by-step guide includes steps associated with:
(1) the dietary program,
(2) the medicine compliance program,
(3) the tobacco addiction program,
(4) the stress management program,
(5) the exercise program, and
(6) the medical record keeping program.

9. The system of claim 1, wherein the plurality of secondary steps includes dietary program steps, the dietary program steps including at least three of:
(a) instructions on how to eat less salt,
(b) instructions on how to eat less fat,
(c) instructions on how to eat more fiber,
(d) instructions on how to eat out, and
(e) a shopping list.

10. The system of claim 1, wherein the plurality of secondary steps includes medicine compliance program steps, the medicine compliance program steps including at least two of:
(a) instructions on how to schedule ordering of additional pills,
(b) instructions on how to organize pills, and
(c) information on the purpose of different types of pills.

11. The system of claim 1, wherein the plurality of secondary steps includes tobacco addiction program steps, the tobacco addiction program steps including at least three of:
(a) facts about people who try to quit smoking,
(b) a shopping list,
(c) instructions on marking a calendar, and
(d) instructions on alternatives to smoking.

12. The system of claim 1, wherein the plurality of secondary steps includes stress management program steps, the stress management program steps including at least three of:
(a) an explanation of stress,
(b) a list of stress signs,
(c) a list of ways to manage stress, and
(d) a plurality of anti-stress exercises.

13. The system of claim 1, wherein the plurality of secondary steps includes exercise program steps, the exercise program steps including at least two of:
(a) information about the benefits of walking,
(b) a list of things needed for walking, and
(c) a walking schedule.

14. The system of claim 1, wherein the plurality of secondary steps includes medical record keeping program steps, the medical record keeping program steps including at least three of:
(a) medication compliance recording,
(b) weight recording,
(c) blood pressure recording,
(d) exercise recording,
(e) tobacco consumption recording, and
(f) pain recording.

15. The system of claim 1, wherein the plurality of secondary steps includes a medical record keeping step and the system includes a medical record keeping form, the medical record keeping form including at least three of:
(a) a place to record answers to questions posed to a doctor,
(b) a place to record blood test results,
(c) a place to record prescription medication information,
(d) a place to record blood pressure readings,
(e) a place to record body weights,
(f) a place to record tobacco consumption, and
(g) a place to record pain information.

16. A method for integrated blood pressure control and coronary artery care, the method comprising:
providing a blood pressure monitor;
providing a pill organizer;
providing a nitroglycerin dispenser
providing a stress management guide;
providing a primary step-by-step guide, the primary step-by-step guide including a plurality of primary steps associated with blood and arteries including at least three of:
(1) a dietary program,
(2) a medicine compliance program,
(3) a tobacco addiction program,
(4) a stress management program,
(5) an exercise program, and
(6) a medical record keeping program; and
providing at least one secondary step-by-step guide, the secondary step-by-step guide including a plurality of secondary steps associated with at least one of the primary steps.

17. A system for integrated blood pressure control and coronary artery self-care by a user, the system comprising:
a blood pressure monitor;
a primary step-by-step guide associated with the blood pressure monitor, the primary step-by-step guide including a plurality of primary steps associated with blood and arteries including at least five of:
(1) a dietary program,
(2) a medicine compliance program,
(3) a tobacco addiction program,
(4) a stress management program,
(5) an exercise program, and
(6) a medical record keeping program;
at least one secondary step-by-step guide, the secondary step-by-step guide including a plurality of secondary steps associated with at least one of the primary steps; and
a container for the above components.
